(19) United States
(12) Patent Application Publication
(10) Pub. No.: US 2005/0005996 A1
(43) Pub. Date: Jan. 13, 2005

(54) Liquid droplet ejection apparatus, method of ejecting liquid droplet, method of manufacturing electrooptic device, electrooptic device, electronic device, and substrate

(76) Inventor: Seigo Mizutani, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/844,619

(22) Filed: May 12, 2004

(30) Foreign Application Priority Data
May 14, 2003 (JP) 2003-136479

(51) Int. Cl. B05D 5/12; B41J 2/01

(52) U.S. Cl. 141/25; 427/58; 427/256; 427/8; 118/300

(57) ABSTRACT

A liquid droplet ejection apparatus which selectively ejects a function liquid from a nozzle array arranged in a function liquid droplet ejection head is made up of: a linear scale which is constituted by a mark array continuously marked on a workpiece; an encoder which is constituted by a linear sensor which faces the linear scale; and a drive control means which controls the driving of the function liquid from the nozzle arrays. The linear scale has a reference mark which shows the position of starting the detection of each of the imaging regions arranged in a perpendicular direction relative to the direction of detection of the linear sensor. The reference mark is marked in a mode which is different from a mode of the other marks.

### BACKGROUND OF THE INVENTION

1. Field of the Invention

This invention relates to a liquid droplet ejection apparatus which performs imaging on a workpiece by selectively ejecting a function liquid from a nozzle array which is disposed in a function liquid droplet ejection head; a method of ejecting liquid droplets; a method of manufacturing an electrooptic device; an electronic device; and a substrate.

2. Description of the Related Art

Conventionally, since an ink jet printer (liquid droplet ejection apparatus) using an ink jet type of print head can eject minute ink droplets (function liquid) in dot form, an application thereof is expected to the field of manufacturing various kinds of parts. Recently, it is used also in a method of manufacturing a so-called flat display, e.g., of an organic electroluminescence (EL) display device, a liquid crystal display device, or the like. A function liquid, e.g., of a light emitting material, filter material, or the like, is ejected on a glass substrate (workpiece) to thereby perform the forming of an EL light emitting layer, a hole injection layer, or the like, in each pixel in the organic EL display device; as well as the forming of filter elements of red (R), green (G), and blue (B), or the like, in the liquid crystal display device. In this case, since the function liquid is ejected into minute cavities partitioned by the bank portions, ejection control of higher accuracy inclusive of ejection position and ejection timing is required. As a solution, in the method of manufacturing this kind of display device, generally the following ejection control is performed, i.e., instead of performing the ejection control by counting a clock number inside a control circuit on the assumption that the carriage or the workpiece carried by the print head is operated at a slow speed, an encoder (a rotary encoder or a linear encoder) is used to perform the position detection of the carriage or the workpiece, and the ejection control is performed based on the detection result (output of the encoder signal).

In case the above-described organic EL device or the liquid crystal display device is manufactured, the ejection accuracy on the side of the print head can be compensated for to a certain degree by controlling the ejection timing of the ink based on the encoder signal as described above. However, since glass substrate is often used as the substrate, the substrate size varies by thermal expansion due to temperature changes, resulting in a problem in that the function liquid is caused to land on a position deviating from the desired ejection position.

Therefore, in case, e.g., an encoder is used, the linear scale is constituted by the same material as that of the glass substrate to thereby compensate for the positional deviation due to thermal expansion. However, due to a difference in size and thickness of glass, there occurs a difference in respective expansion coefficients. Further, since the linear scale is mainly disposed on a side portion, or the like, of a moving table on which the glass substrate is mounted, the expansion coefficients may vary also with the temperature distribution at the positions of disposition of the glass substrate and the linear scale. Therefore, in case of using a substrate constituted by a material, such as glass, which may give rise to a thermal expansion or deformation due to temperature change, it was difficult to eliminate the deviation in ejection position due to temperature change, even if a liner encoder is used.

### SUMMARY OF THE INVENTION

In view of the above-described problems, this invention has an advantage of providing a liquid droplet ejection apparatus which is capable of maintaining the accuracy of ejecting the function liquid even in case a change has occurred to the substrate size due to a temperature change; a method of ejecting a liquid droplet; a method of manufacturing an electrooptic device; an electrooptic device; an electronic device; and a substrate.

According to this invention, there is provided a liquid droplet ejection apparatus for forming an image on a workpiece by selectively ejecting a function liquid from a nozzle array disposed in a function liquid droplet ejection head, the apparatus comprising: a head unit made up by mounting the function liquid droplet ejection head on a carriage; a moving mechanism for performing a relative movement between the head unit and a workpiece, the workpiece having a plurality of imaging regions arranged in a matrix and a non-imaging region to partition the imaging regions; a linear encoder made up of a linear scale formed by a mark array continuously marked on the workpiece and of a linear sensor facing the linear scale, the linear encoder detecting a position of relative movement between the head unit and the workpiece; drive control means for controlling drive of ejection of the function liquid from the nozzle array based on a result of counting of the linear scale by the linear sensor; wherein the linear scale has a reference mark indicating a detection start position of each of the imaging regions, the reference mark being disposed in a perpendicular direction relative to the detection direction of the linear sensor, the reference mark being marked in a mode different from a mode of other marks, and wherein the drive control means resets counting of the linear scale by the linear sensor based on detection of the reference mark.

According to another aspect of this invention, there is provided a method of ejecting liquid droplets by selectively ejecting a function liquid from a nozzle array disposed in a function liquid droplet ejection head, thereby forming an image on a workpiece, the method comprising the steps of: performing a relative movement between a head unit made up by mounting the function liquid droplet ejection head on a carriage, and a workpiece having a plurality of imaging regions arranged in a matrix and a non-imaging region to partition the imaging regions; detecting a position of a relative movement between the head unit and the workpiece by a linear scale formed by a mark array continuously marked on the workpiece and a linear sensor facing the linear scale; and controlling drive of ejection of the function liquid from the nozzle array based on a result of counting of the linear scale by the linear sensor; wherein the linear scale has formed therein a reference mark indicating a detection start position of each of the imaging regions, the reference mark being marked in a perpendicular direction relative to the detection direction of the linear sensor in a mode different from a mode of other marks, and wherein, in the drive control step, counting of the linear scale by the linear sensor is reset based on detection of the reference mark.

According to the above arrangements, since the linear scale is constituted by a mark array marked on the workpiece, the ejection accuracy of the function liquid can be maintained even in case the workpiece varies in size due to a temperature change. In addition, the linear scale has a reference mark marked in a mode which is different from the mode of the other marks, and the counting of the linear scale by the linear sensor is reset based on detection of the reference mark. Therefore, in case a detection error such as a skipping in reading or double counting has occurred, the error can be compensated for each of the imaging region arrays. Further, since the reference mark shows the starting position of detection in each of the imaging region arrays, after a detection error has occurred, the ejection accuracy can be maintained from the ejection start position in the subsequent imaging region. Still furthermore, since the mark array is continuously marked on the workpiece, the detection can be carried out continuously by the linear sensor in all of the regions (imaging regions and non-imaging regions). As a result, the ejection accuracy can further be improved.

Preferably, the linear scale is formed in the non-imaging region.

According to the above arrangement, since the linear scale is formed in the non-imaging region, there is no effect on the imaging region which is later cut out and used as a product.

Preferably, the number of marks corresponding to each of the imaging regions of the mark array is equivalent to the number of ejection of the function liquid into the imaging region.

According to the above arrangement, since the number of the marks corresponding to each of the imaging regions of the mark array is equal to the number of ejection of the function liquid into the imaging region, it is possible in the imaging region to perform the drive control of the ejection timing in a simple arrangement in which the ejection is made once whenever a mark is detected. Therefore, the duty of the control apparatus (CPU and the like) can be reduced.

Preferably, each of the imaging regions has a plurality of cavity portions into which the function liquid is ejected to constitute pixels and bank portions to partition the cavity portions, and the linear sensor detects the bank portions instead of the mark array.

According to the above arrangement, the bank portions to partition the pixels (cavity portions) can be used as a linear scale. Therefore, even in case a workpiece which gives rise to thermal expansion or deformation accompanied by the temperature change is used, the ejection accuracy can be maintained without the necessity of the step of forming the linear scale (the step of marking on the workpiece).

Preferably, the non-imaging region has a detecting bank portion which is of the same material as the bank portion in the imaging region and which is capable of being used as the mark array, and the linear sensor detects the detecting bank portion.

According to the above arrangement, the detecting bank portion can be formed in the same step of forming the bank portion in the imaging region and this can be used as the liner scale. Therefore, the step of forming the linear scale (the step of marking on the workpiece) is not required. Further, since the detecting bank portion is formed in the non-imaging region, the distance between the bank portions can be freely set depending on the number of ejection of the function liquid, or the like.

Preferably, the linear scale is made up of a scale number which is equivalent to a relative number of scanning of the workpiece by the head unit.

According to the above arrangement, since the linear scale has the number of scale equivalent to the number of scanning, the positions of the head unit and the linear sensor are fixed. Therefore, even in case the imaging is made by dividing into a plurality of numbers, the ejection accuracy can be maintained.

Preferably, the imaging region is subjected to imaging by ejection of plural kinds of function liquids, and the liner encoder detects linear scales made up of a number of scales equivalent to the number of kinds of the function liquids by means of the linear sensor corresponding to each of the linear scales.

According to the above arrangement, the linear scale can be detected, e.g., for each kind of the plurality of function liquids. Therefore, even in case the plural kinds of ejection liquids are ejected, there is not required a table, a processing program, or the like, which correlates the mark position and the kind of the function liquid to be ejected at the time of detecting the mark. Each of the nozzle arrays can thus be simply controlled for driving.

Preferably, the head unit has disposed therein a plurality of nozzle arrays through the function liquid droplet ejection head, and a mark array of the linear scale has a mark interval of 1/n (n is an integer above 1) when a distance between each of the nozzle arrays is defined as 1, and further comprises a corresponding table which correlates a mark position of the mark array with ejection/non-ejection of the function liquid of each of the nozzle arrays when the mark position is detected. The drive control means controls drive of ejection of the function liquid from each of the nozzle arrays by reference to the corresponding table.

According to the above arrangement, in case a plurality of nozzle arrays are arranged in the head unit, there naturally occurs the distance 1 between the nozzle arrays. By disposing the mark by making this distance 1 between the nozzle arrays to be an integer multiple, it is possible to use the corresponding table which correlates the mark position and the ejection/non-ejection of the function liquid of each of the nozzle arrays when the mark position is detected. In other words, by referring to the corresponding table, the ejection/non-ejection of each of the nozzle arrays can be simply determined. As a result, there is no possibility that the ejection position deviates due to the distance that occurs between the nozzle arrays. Therefore, even in case where the imaging is performed by a plurality of nozzle arrays, each of the nozzle arrays can be easily controlled for driving without using a processing program, or the like.

Preferably, the head unit has disposed therein a plurality of nozzle arrays through the function liquid droplet ejection head. One of the plurality of nozzle arrays is defined as a reference nozzle and, when the liner encoder detects linear scales made up of equivalent to the number of kinds of the function liquids by means of the linear sensor corresponding to each of the linear scales, a mark array constituting each of the linear scales is disposed at a position offset by a distance from the reference nozzle array of the corresponding nozzle array, as seen in a detection direction of the linear sensor.

According to the above arrangement, in case the plurality of nozzle arrays are disposed in the head unit, there occurs a distance between the nozzle arrays. However, in a linear scale having the number of scales corresponding to the number of nozzle arrays, by disposing the mark position of each of the scale at a position offset by the distance from the reference nozzle array which serves as a reference, there is no possibility that the ejection position deviates due to the distance that occurs between the nozzle arrays. Further, since the linear scale has the scale number corresponding to the number of nozzle arrays and the liner scale is detected for each of the nozzle arrays, each of the nozzle arrays can be simply controlled for driving without the need of a table, a processing program, or the like, which correlates the mark position and the nozzle arrays for ejection at the time of detection of the mark.

According to another aspect of this invention, there is provided a liquid droplet ejection apparatus for forming an image on a workpiece by selectively ejecting a function liquid from a nozzle array disposed in a function liquid droplet ejection head, the apparatus comprising: a head unit made up by mounting said function liquid droplet ejection head on a carriage; a moving mechanism for performing a relative movement between the head unit and a workpiece, the workpiece having a plurality of imaging regions arranged in a matrix and a non-imaging region to partition the imaging regions; a linear encoder made up of a linear scale formed by a mark array continuously marked on the workpiece and of a linear sensor facing the linear scale, the linear encoder detecting a position of relative movement between the head unit and the workpiece; drive control means for controlling drive of ejection of the function liquid from the nozzle array based on a result of counting of the linear scale by the linear sensor; wherein each of the imaging regions has a plurality of cavity portions into which the function liquid is ejected to constitute pixels, and bank portions to partition the cavity portions; and wherein the linear scale is constituted by the bank portions.

According to still another aspect of this invention, there is provided a method of ejecting liquid droplets by selectively ejecting a function liquid from a nozzle array disposed in a function liquid droplet ejection head, thereby forming an image on a workpiece, the method comprising the steps of: performing a relative movement between a head unit made up by mounting the function liquid droplet ejection head on a carriage, and a workpiece having a plurality of imaging regions arranged in a matrix and a non-imaging region to partition the imaging regions; detecting a position of a relative movement between a linear scale formed by a mark array continuously marked on the workpiece, and a linear sensor facing the linear scale; and controlling drive of ejection of the function liquid from the nozzle array based on a result of counting of the linear scale by the linear sensor; wherein the imaging regions have formed therein a plurality of cavity portions into which the function liquid is ejected to constitute pixels, and bank portions to partition the cavity portions; and wherein the linear scale is formed by the bank portions.

According to the above arrangement, since the linear scale is formed on the workpiece, even in case the workpiece changes in size due to temperature changes, the accuracy of ejection of the function liquid can be maintained. Further, since the bank portions to partition the pixels are used as the linear scale, the step of forming the linear scale (the step of marking on the workpiece) can be eliminated.

Preferably, the bank portions which are objects of detection by the linear sensor are formed continuously in the detection direction also in the non-imaging region.

According to the above arrangement, detection by the linear sensor can be continuously made also in the non-imaging region. As a result, the accuracy of ejection can further be improved.

Preferably, the non-imaging region has a detecting bank portion which is of the same material as the bank portion in the imaging region and which is capable of being used as the mark array, and the linear scale is constituted by the detecting bank portion.

According to the above arrangement, the detecting bank portion can be formed in the same step as the bank portion of the imaging region and can be used as the linear scale. Therefore, the step of forming the linear scale (the step of marking on the workpiece) is not required. Further, since the detecting bank portion is formed in the non-imaging portion, the bank spacing can be freely set depending on the number of ejection of the function liquid, or the like.

According to still another aspect of this invention, there is provided a method of manufacturing an electrooptic device comprising forming on a workpiece a film-forming portion by a function liquid by using the above-described liquid droplet ejection apparatus.

According to the above arrangement, a high-quality electrooptic device can be manufactured because it is manufactured by using the liquid droplet ejection apparatus which is capable of maintaining the accuracy of ejecting the function liquid even in case a change occurs to the substrate due to a temperature change. As the electrooptic device, there can be listed a liquid crystal display device, an organic electroluminescence (EL) device, an electron emission device, a plasma display panel (PDP) device, and an electrophoretic display device. The electron emission device is a concept inclusive of a so-called field emission display (FED) device. Further, as the electrooptic device, there can be considered a device inclusive of one for forming metallic wiring, forming a lens, forming a resist, forming a light diffusion member, or the like.

According to another aspect of this invention, there is provided an electronic device having mounted thereon the above-described electrooptic device.

The electronic device includes a mobile phone, a personal computer, and other electric devices having mounted thereon a so-called flat display panel.

According to still another aspect of this invention, there is provided a substrate for use as the workpiece in the above-described liquid droplet ejection apparatus.

As the substrate, there may be used various kinds of materials such as glass, resin (film), or the like, depending on the electrooptic device to be manufactured.

### BRIEF DESCRIPTION OF THE DRAWINGS

FIG. 1 is a sectional view of an organic EL device relating to a first embodiment of this invention;

FIGS. 2A through 2C are explanatory views showing arrangements of red, green, and blue pixels relating to the above embodiment;

FIG. 3 is a schematic plan view of a liquid droplet ejection apparatus relating to the above embodiment;

FIG. 4 is a plan view showing an example of a workpiece and a linear scale formed on the workpiece relating to the above embodiment;

FIG. 5 is a control block diagram showing a control constitution of the liquid droplet ejection apparatus relating to the above embodiment;

FIG. 6 is a plan view showing an example of arrangement of the linear scale and the pixels;

FIG. 7 is a perspective view showing an example of the linear scale and the pixels relating to the above embodiment;

FIG. 8 is a figure showing one example of a corresponding table correlating the mark position and the ejection/non-ejection of the nozzle relating to the above embodiment;

FIG. 9 is a plan view showing another example of the workpiece and the linear scale formed on the workpiece;

FIGS. 10A and 10B are perspective views showing cavity portions in imaging region, bank portions which partition them, and the linear sensor which detects the bank portions, relating to a second embodiment;

FIG. 11 is a perspective view showing detecting bank portions which are formed in the non-imaging region, and the linear sensor which detect the detecting bank portions, relating to the second embodiment;

FIG. 12 is a plan view showing an example of arrangement of the linear scale and the pixels, relating to a third embodiment;

FIG. 13 is a plan view showing an example of arrangement of the linear scale and the pixels, relating to a third embodiment;

FIG. 14 is a figure showing one example of a corresponding table correlating the mark position and the ejection/non-ejection of each of the nozzles at the time of detecting the mark position, relating to the third embodiment;

FIG. 15 is a perspective view showing an example of arrangement of the linear scale and the pixels, relating to the third embodiment;

FIG. 16 is a plan view showing an example of arrangement of the linear scale and the pixels, relating to the third embodiment;

FIG. 17 is a plan view showing an example of a workpiece and a linear scale which is formed on the workpiece, relating to a fourth embodiment;

FIG. 19 is a plan view showing an example of a workpiece and a linear scale which is formed on the workpiece, relating to a fifth embodiment;

FIG. 20 is a plan view showing a deviation in transportation of the workpiece, relating to the fifth embodiment; and

FIG. 21 is a flow chart showing the correction processing of the ejection timing of each of the nozzles relating to the fifth embodiment.

### DETAILED DESCRIPTION OF THE PREFERRED EMBODIMENTS

A description will now be made about a liquid droplet ejection apparatus, a method of manufacturing an electrooptic device, an electrooptic device, an electronic device, and a substrate according to an embodiment of this invention. The liquid droplet ejection apparatus of this embodiment is to be built in a manufacturing line of an organic EL device which is a kind of a so-called flat panel display, and to form a light emitting element (film forming portion) which constitutes each pixel of the organic EL device.

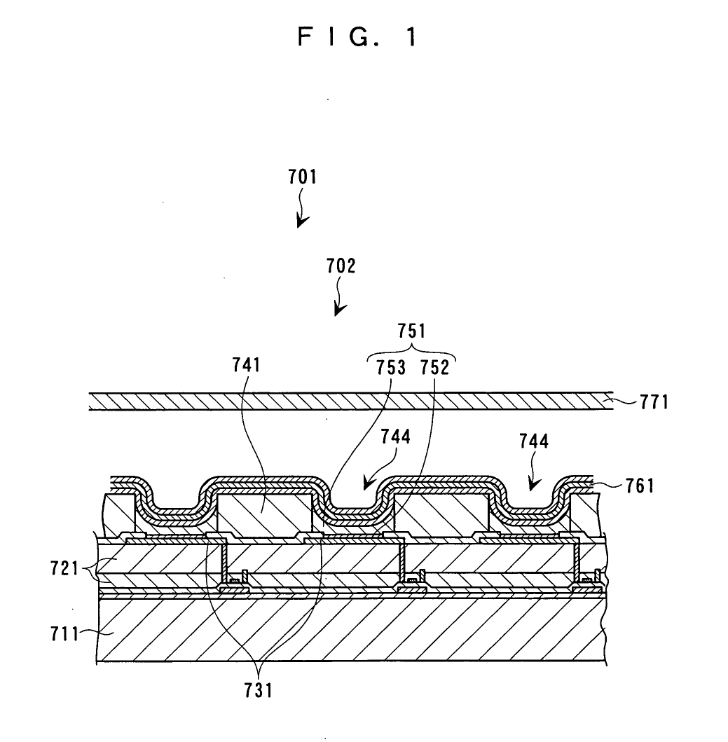

Prior to the explanation of the liquid droplet ejection apparatus, an explanation will first be made briefly about the organic EL device and the step of its manufacturing. FIG. 1 is a figure showing a sectional view of an organic EL device.

As shown in the figure, the organic EL device 701 is made up by connecting a wiring of a flexible substrate (not illustrated) and a driving IC (not illustrated) to an organic EL element 702 which is constituted by a substrate 711, a circuit element portion 721, a pixel electrode 731, a bank portion 741, a light emitting element 751, a cathode 761 (opposite electrode), and a sealing substrate 771.

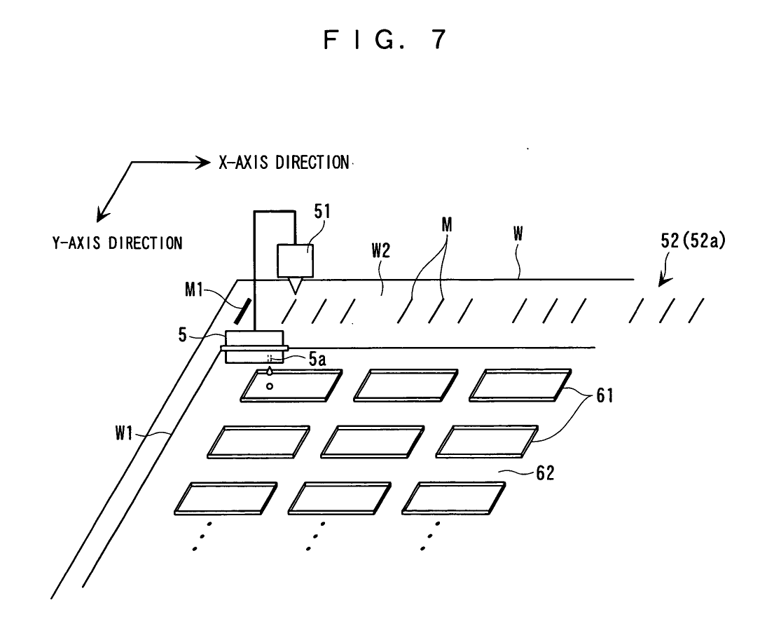

As shown, on a substrate 711 of the organic EL element 702, there is formed the circuit element portion 721 and, on the circuit element portion 721, there are arranged a plurality of pixel electrodes 731. Between each of the pixel electrodes 731, there are formed bank portions 741 in a lattice shape. Inside recessed openings 744 (cavity portions 62: see FIG. 7) generated by the bank portions 741, the light emitting elements 751 are formed. Over an entire upper surface of the bank portions 741 and the light emitting elements 751, there is formed the cathode 761 and, on the cathode 761, there is laminated the sealing substrate 771.

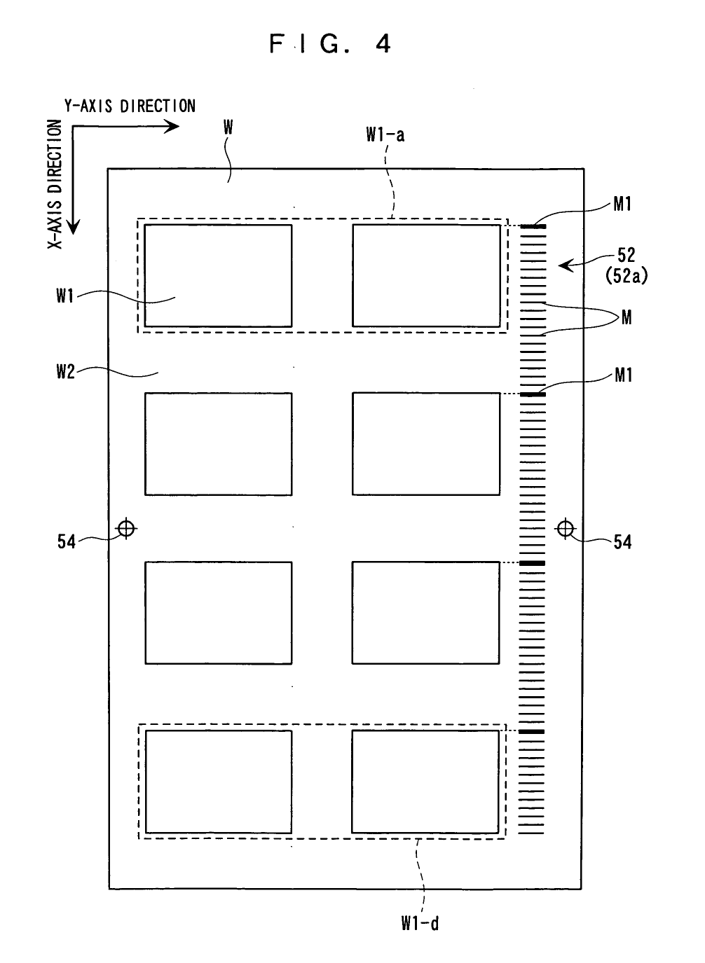

The manufacturing process of the organic EL element 701 is made up of: a bank portion forming step to form the bank portions 741; a plasma processing step to adequately form the light emitting elements 751; a light emitting element forming step to form the light emitting elements 751; an opposite electrode forming step to form the cathode 761; and a sealing step to laminate the sealing substrate 771 on top of the cathode 761 to thereby seal it. In other words, after forming the bank portions 741 in the imaging region W1 of the substrate 711 (workpiece W: see FIG. 4, or the like) in which is formed in advance the circuit element portion 721 and the pixel electrodes 731, the steps of plasma processing, and of forming the light emitting elements 751 and the cathode 761 (opposite electrode) are performed in sequence, and further by laminating the sealing substrate 771 on top of the cathode 761. Since the organic EL element 702 is likely to be deteriorated under the influence of the moisture, or the like, in the atmosphere, the manufacturing of the organic EL element 702 shall preferably be carried out in an atmosphere of dry air or in an inert gas (nitrogen, argon, helium, or the like).

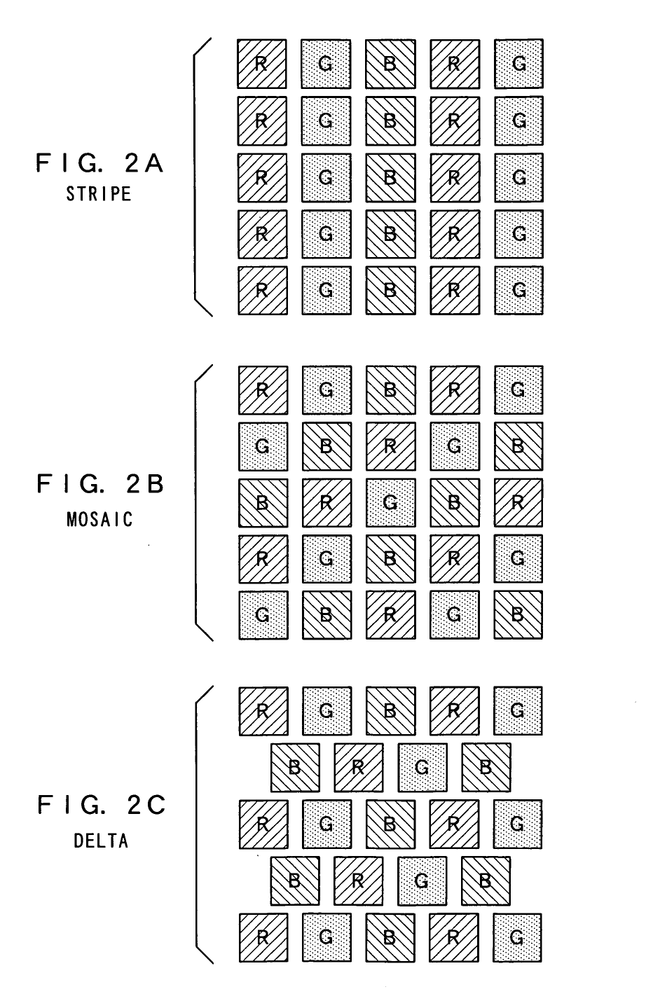

Each of the light emitting elements 751 is constituted by a film forming portion which is made up of a hole injection/transport layer 752 and a light emitting layer 753 which is colored into any one of red \mathring{R}, green (G) and blue (B). The light emitting element forming step includes a hole injection/transport layer forming step to form the hole injection/transport layer 752, and a light emitting layer forming step to form the three-color light emitting layer 753. In this case, as the arrangement of three colors of light emitting layers 753 relative to a multiplicity of recessed openings 744 of matrix shape as partitioned by the above-described bank portions 741, there are known as shown in FIG. 2 a stripe arrangement (FIG. 2A), a mosaic arrangement (FIG. 2B), and a delta arrangement (FIG. 2C).

Then, the organic EL device 701 is manufactured, after having manufactured the organic EL element 702, by connecting the wiring of the flexible substrate to the cathode electrode 761 of the organic EL element 702, and by connecting the wiring of the circuit element portion 721 to the driving IC.

The liquid droplet ejection apparatus of this embodiment is divided into one which is used for the injection/transport layer forming step and one which is used for light emitting layer forming step. Since the same construction is used as the apparatus itself, description will be made in detail here by taking as an example the liquid droplet ejection apparatus for forming the light emitting layer 752 of three colors of R, G, and B.

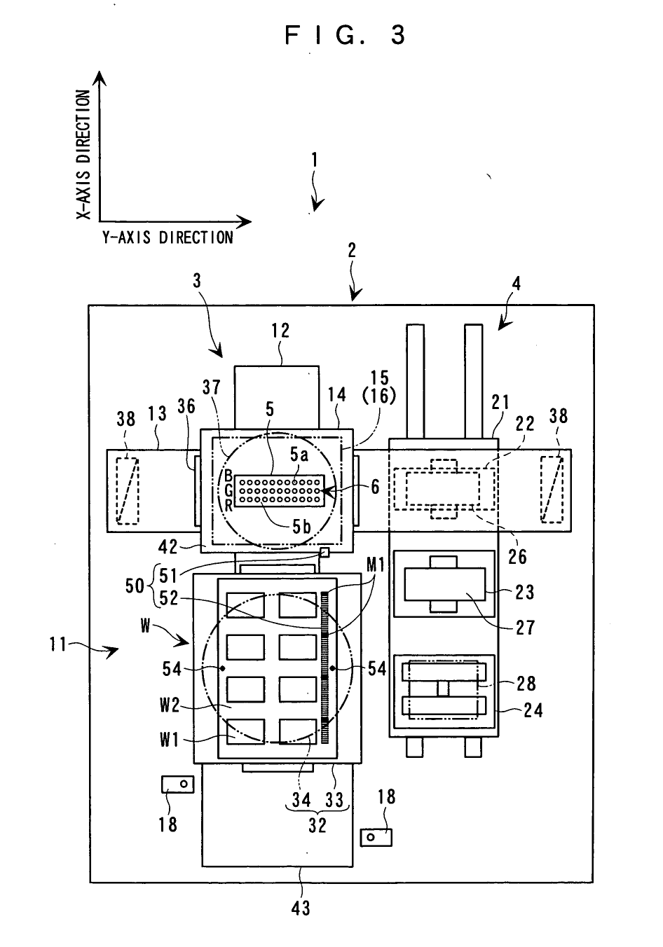

As shown in a schematic plan view of FIG. 3, the liquid droplet ejection apparatus 1 of this embodiment is made up of: an apparatus base 2, an imaging apparatus 3 which is widely mounted over an entire area of the apparatus base 2; and a head function recovery apparatus 4 which is mounted on the apparatus base 2 so as to lie in a side by side relationship with the imaging apparatus 3. Imaging by the function liquid is performed on the imaging region W1 of the workpiece W by the imaging apparatus 3, and the function recovery processing (maintenance) of the function liquid droplet ejection head 5 which is provided in the imaging apparatus 3 is adequately performed by the head function recovery apparatus 4.

The imaging apparatus 3 is provided with: an X Y moving mechanism 11 which is made up of an X-axis table (main scanning means) 12 and a Y-axis table 13 crossing at right angles to the X-axis table 12; a main carriage 14 which is movably mounted on the Y-axis table 13; and a head unit 15 which is mounted so as to be suspended from the main carriage 14. In the head unit 15, there is mounted thereon, through a sub-carriage 16, the function liquid droplet ejection head 5 which has arranged thereon three nozzle arrays 6 of red color, green color, and blue color. Also mounted on the head unit 15 is a linear sensor 51 in a manner to correspond to the position of a linear scale 52 formed on the workpiece W.

In this case, the workpiece W which is a substrate is constituted by a translucent (transparent) glass substrate. At a stage in which the workpiece W is transported onto the X-axis table 12, a pair of workpiece reference marks 54, 54 are recognized by a pair of workpiece recognition cameras 18, 18 which face the X-axis table 12, so that the workpiece W is set to the X-axis table 12 in a positioned state. The workpiece W has disposed therein imaging regions W1 which are disposed in matrix and in which the function liquid is ejected (i.e., in which imaging work is performed), and non-imaging regions W2 which serve to partition the imaging regions W1 and in which the linear scale 52 is formed. In the illustrated sub-carriage 16, there is mounted a function liquid droplet ejection head 5 in which three nozzle arrays 6 are arranged. However, the sub-carriage 16 may have mounted thereon these three nozzle arrays 6 arranged on different function liquid droplet ejection heads 5. Further, each of the nozzle arrays 6 corresponding to the respective colors may be constituted in a plurality of arrays.

The linear sensor 51 is an optical type of light-receiving sensor which is made up of a light-generating portion and a light-receiving portion (both not illustrated) which are disposed in an up and down relationship with the workpiece W therebetween, and is arranged to detect the linear scale 52 which is formed on the workpiece W. These linear sensor 51 and the linear scale 52 constitute a linear encoder 50.

As shown in FIG. 4, the linear scale 52 is constituted by a mark array 52a which is made up of a plurality of marks M and extends in the direction of detection by the linear sensor 51 (in the X-axis direction). In addition, the mark array 52a is continuously marked from that detection start position in an imaging region array W1-a which is positioned at the illustrated uppermost stage (position of starting detection by the linear sensor 51) in the imaging region W1 arranged in matrix on the workpiece W, to that detection end position in an imaging region array W1-d which is positioned at the illustrated lowermost stage (position of ending detection by the linear sensor 51). At the detection start position of each of the imaging region arrays W1-a through W1-d, there is formed a reference mark M1. This reference mark M1 is to reset the counting of the linear scale 52 by the linear sensor 51. It is so arranged that, in case a detection error occurs such as skipping or double counting, compensation can be made for each of the imaging region arrays W1-a through W1-d. The drive control of ejection of the function liquid based on the linear scale 52 and the detection result will be described in detail hereinafter.

According to the above arrangement, the linear encoder 50 irradiates light from the light-emitting portion, and the light passing between the marks M (translucent portion) is received by the light-receiving portion 5 for conversion into electric signals to thereby generate encoder signals. Then, based on the encoder signals, the moving position information of the main carriage 14 (head unit 15) can be obtained. Depending on the moving position information, the signal of ejection of the function liquid by the function liquid droplet ejection head 5 is generated (ejection timing is determined) to thereby perform imaging on a predetermined position on the workpiece W.

In this embodiment, the optical type of linear encoder is used, but there may be used a magnetic type of linear encoder in which the linear scale made up of a magnetized marking is detected by a magnetic sensor.

On the other hand, the head function recovery apparatus 4 is made up of: a moving table 21 mounted on the apparatus base 2; and a storing unit 22, a suction unit 23 and a wiping unit 24 which are mounted on the moving table 21. The storing unit 22 is to seal the nozzles 5a of the function liquid droplet ejection head 5 during non-operating time of the apparatus, to prevent them from getting dried. The suction unit 23 has a function of a flushing box which forcibly sucks the function liquid from the function liquid droplet ejection head 5, and which receives the waste ejection of the function liquid from all of the nozzles 5a of the function liquid droplet ejection head 5. The wiping unit 24 mainly performs wiping (wiping out) of the nozzle surface 5b of the function liquid droplet ejection head 5 after the suction of the function liquid has been performed.

The storing unit 22 is provided with a sealing cap 26 corresponding, e.g., to the function liquid droplet ejection head 5 in a manner to be movable up and down. At the time of operation stopping of the apparatus, the cap 26 moves to face (the function liquid droplet ejection head 5 of) the head unit 15 so as to be brought into close contact with the nozzle surface 5b of the function liquid droplet ejection head 5, to thereby seal it. According to this arrangement, the function liquid can be prevented from evaporating at the nozzle surface 5b of the function liquid droplet ejection head 5, thereby preventing the so-called nozzle clogging.

Similarly, the suction unit 23 is provided, e.g., with a suction cap 27 corresponding to the function liquid droplet ejection head 5 in a manner to be movable up and down. At the time of filling (the function liquid droplet ejection head 5 of) the head unit 15 with the function liquid, or at the time of removing the function liquid whose viscosity has increased inside the function liquid droplet ejection head 5, the suction cap 27 is brought into close contact with the function liquid droplet ejection head 5, to thereby perform pump suction. At the time of stopping the ejection of (imaging by) the function liquid, flushing (waste ejection) is performed while the suction cap 27 is kept slightly away from the function liquid droplet ejection head 5. According to this arrangement, the nozzle clogging can be prevented or the function liquid droplet ejection head 5 whose nozzle has been clogged can restore the function.

The wiping unit 24 is provided, e.g., with a wiping sheet 28 so as to be capable of being unreeled and taken up and is so arranged that, while feeding the unreeled wiping sheet 28 and while moving the wiping unit 24 in the X-axis direction by the moving table 21, the nozzle surface 5b of the function liquid droplet ejection head 5 is wiped out. Accordingly, the function liquid adhered to the nozzle surface 5b of the function liquid droplet ejection head 5 is removed and the crooked flight, or the like, at the time of ejecting the function liquid can be prevented.

As the head function recovery apparatus 4, it is preferable to mount, aside from each of the above units, an ejection inspection unit to inspect the flight condition of the function liquid ejected from the function liquid droplet ejection head 5, a weight measuring unit to measure the weight of the function liquid ejected from the function liquid droplet ejection head 5, or the like. Further, although not illustrated in the figure, this liquid droplet ejection apparatus 1 has assembled therein a function liquid feeding mechanism for feeding the function liquid into each of the function liquid droplet ejection heads 5, a control apparatus (control means; to be described hereinafter) for performing an overall control of the constituting apparatuses such as the above-described imaging apparatus 3, the function liquid droplet ejection head 5, or the like.

The X-axis table 12 has a motor-driven X-axis slider 31 which constitutes the driving system in the X-axis direction and is constituted by movably mounting a set table 32 which is made up of a suction table 33, a Θ table 34, or the like. Similarly, the Y-axis table 13 has a motor-driven Y-axis slider 36 which constitutes the driving system in the Y-axis direction and is constituted by movably mounting the above main carriage 14 through the Θ table 34.

In this case, while the X-axis table 12 is directly supported on the apparatus base 2, the Y-axis table 13 is supported by the left and right supporting columns 38, 38 which are vertically disposed on the apparatus base 2. The X-axis table 12 and the head function recovery apparatus 4 are disposed in parallel with each other, and the Y-axis table 13 extends in a manner to bridge the X-axis table 12 and the moving table 21 of the head function recovery apparatus 4.

The Y-axis table 13 appropriately moves the head unit 15 (function liquid droplet ejection head 5) which is mounted thereon between a function recovery area 41 which is positioned right above the head function recovery apparatus 4 and an imaging area 42 which is positioned right above the X-axis table 12. In other words, the Y-axis table 13 causes the head unit 15 to face the function recovery area 41 when the function recovery of the function liquid droplet ejection head 5 is performed and causes the head unit 15 to face the imaging area 42 when the imaging is performed on the workpiece W introduced into the X-axis table 12.

On the other hand, one end portion of the X-axis table 12 is made to be a transfer area 43 for setting (transferring) the workpiece W on the X-axis table 12. In the transfer area 43 there are disposed the pair of the workpiece recognition cameras 18, 18. By means of these pair of workpiece recognition cameras 18, 18, the reference marks 54, 54 in two positions of the workpiece W fed to the suction table 33 can be simultaneously recognized. Based on the result of this recognition, the alignment of the workpiece W is performed.

In the liquid droplet ejection apparatus 1 (imaging apparatus 3) of this embodiment, the movement of the workpiece W in the X-axis direction is defined as the main scanning, and the movement of the function liquid droplet ejection head 5 (head unit 15) in the Y-axis direction is defined as the sub-scanning. Based on the ejection pattern data to be stored in the above control means and the detection result of the above linear encoder 50 (encoder signal), imaging is performed.

In case the imaging is performed on the workpiece W introduced into the imaging area 42, the function liquid droplet ejection head 5 (head unit 15) is left to face the imaging area 42 and, in synchronization with the main scanning by the X-axis table 12 (reciprocating movement of the workpiece W), the function liquid droplet ejection head 5 is driven for ejection (selective ejection of the function liquid) based on the detection result of the linear encoder 50. Further, by means of the Y-axis table 13 the sub-scanning (movement of the head unit 15) is appropriately performed. As a result of these series of operations, the desired selective ejection of the function liquid into the imaging region Wa of the workpiece W, i.e., the imaging, can be performed.

In case the function recovery of the function liquid droplet ejection head 5 is performed, the suction unit 23 is moved by the moving table 21 into the function recovery area 41 and also the head unit 15 is moved by the Y-axis table 13 to the function recovery area 41 to thereby perform flushing or pump suction of the function liquid droplet ejection head 5. In case pump suction is performed, the wiping unit 24 is subsequently moved by the moving table 21 to the function recovery area 41 to thereby perform wiping of the function liquid droplet ejection head 5. Similarly, when the operation is stopped as a result of completion of the work, capping is performed onto the function liquid droplet ejection head 5 by means of the storing unit 22.

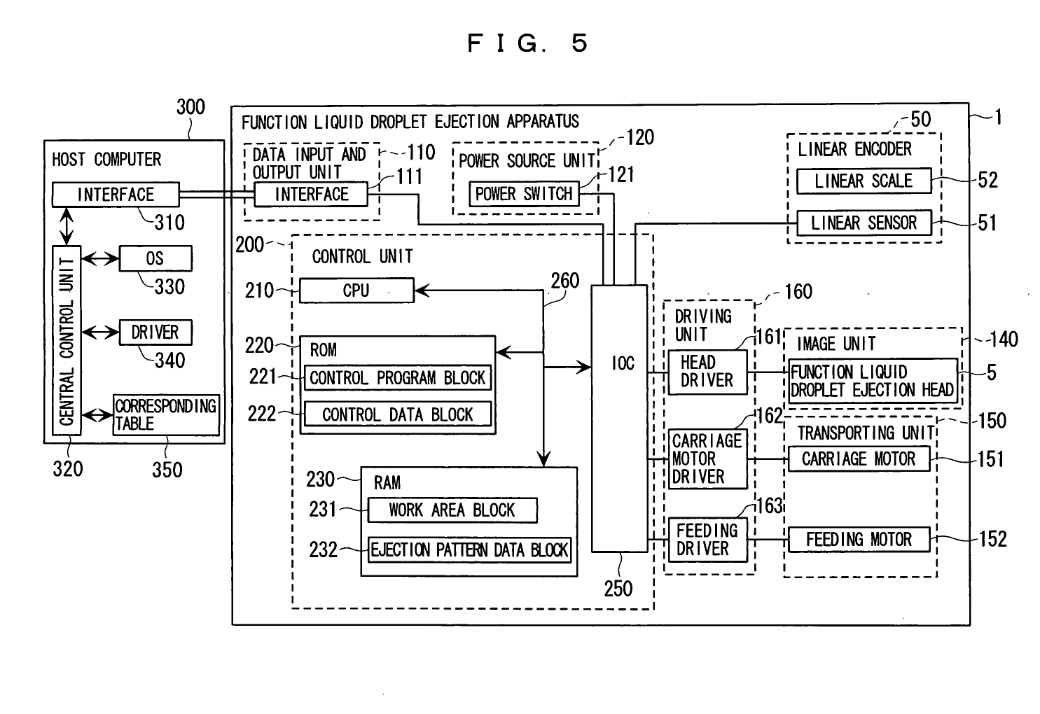

Here, a description will now be made about the control arrangement of the liquid droplet ejection apparatus 1 by reference to the block diagram in FIG. 5. The liquid droplet ejection apparatus 1 is made up of: a data input and output unit 110 which has an interface 111 and which obtains ejection pattern data (data to determine ejection/non-ejection of the function liquid in each of the nozzles 5a), driving waveform data (waveform data to be applied to drive piezoelectric element of each of the nozzles 5a), and various other data which are transmitted from a host computer 300 and which outputs to the host computer 300 data relating to the processing conditions, or the like, inside the liquid droplet ejection apparatus 1; power source unit 120 which performs feeding and shutting of electric power; the linear encoder 50 which has the linear sensor 51 and the linear scale 52 and which detects the moving position of the workpiece W; an imaging unit 140 which has the function liquid droplet ejection head 5 and which performs imaging on the workpiece W; a transporting unit 150 which has a carriage motor 151 and a feeding motor 152 and which moves and transports the main carriage 14 on which the function liquid droplet ejection head 5 is mounted (head unit 15); a driving unit 160 which has a head driver 161, a carriage motor driver 162 and a feeding driver 163 and which drives each part; and a control unit 200 which controls the entire liquid droplet ejection apparatus 10.

The control unit 200 is provided with a CPU 210, a ROM 220, a RAM 230, and an input and output control apparatus 250 (hereinafter referred to as input output controller, IOC) and is connected to an internal bus 260. The ROM 220 has a control program block 221 which stores therein, aside from the program for controlling to drive the ejection of each nozzle 5a (nozzle array 6), various programs to be processed by the CPU 210; and a control data block 222 which stores therein control data inclusive of various tables.

The RAM 230 has, aside from a work area block 231 which is used as flags, or the like, an ejection pattern block 232 which stores therein ejection pattern data transmitted from the host computer 300, and is used as the working area for control processing. The RAM 230 is constantly backed up to keep the stored data in preparation for possible cutting off of the power supply.

In the IOC 250, there is assembled a logic circuit which supplements the function of the CPU 210 and which handles the interface signals with various peripheral circuits, as constituted by gate arrays and custom LSIs. According to this arrangement, the IOC 250 captures ejection pattern data and control data from the host computer 300 as they are or after due processing into the internal buss 260 and, in a manner interlocked with the CPU 210, the data signals outputted from the CPU 210 to the internal buss 260 as they are or after due processing are outputted to the driving unit 160.

According to the above-described arrangement, the CPU 210 inputs various signals/data from the host computer 300 and various parts of the liquid droplet ejection apparatus 1 processes various data inside the RAM 230 based on the control program inside the ROM 220, thereby processing the various data inside the RAM 230, and the CPU 210 outputs various signals/data into each part of the liquid droplet ejection apparatus 1 through the IOC 250, thereby controlling to drive the ejection timing of the function liquid from each of the nozzles 5a, whereby imaging is performed on the workpiece W. In this embodiment, the ejection timing is controlled for driving for each of the nozzle arrays 6 by coinciding the nozzle distance in the nozzle array 6 direction to the pixel pitch. Details thereof will be described hereinafter.

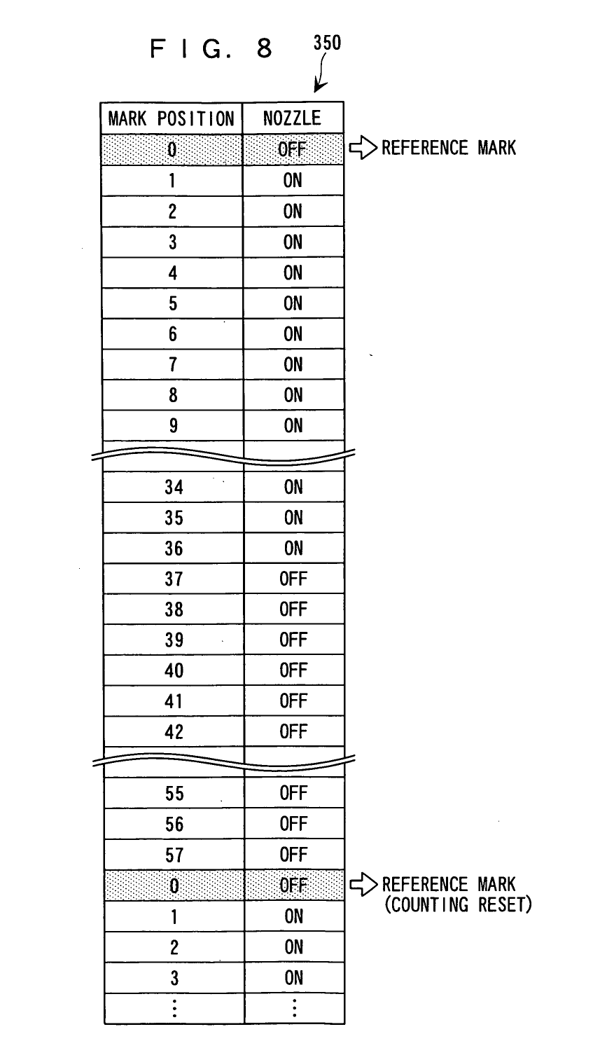

On the other hand, the host computer 300 is provided with: an interface 310 which outputs the ejection pattern data, drive waveform data, and other various control data, and also inputs those data relating to the processing conditions, or the like, inside the apparatus which are transmitted from the liquid droplet ejection apparatus 1; a central control unit 320 which has a memory such as CPU, ROM, RAM, or the like and which performs the control of the entire personal computer; an OS 330 such as Windows (TM); and a driver 340 which controls the liquid droplet ejection apparatus 1. The central control unit 320 (RAM, or the like) has therein a corresponding table 350 (see FIG. 8) for determining the mark position of the linear scale 52 and the ejection/non-ejection corresponding to the mark. By referring to the corresponding table 350, the ejection pattern data to determine the timing of ejecting the function liquid from each of the nozzle arrays 6 are generated.

Instead of driving to control the ejection of the function liquid based on the ejection pattern data as transmitted from the host computer 300, it may alternatively be so arranged that the above-described corresponding table 350 is stored inside the liquid droplet ejection apparatus 1 so that the ejection/non-ejection of each of the nozzle arrays 6 is determined based thereon.

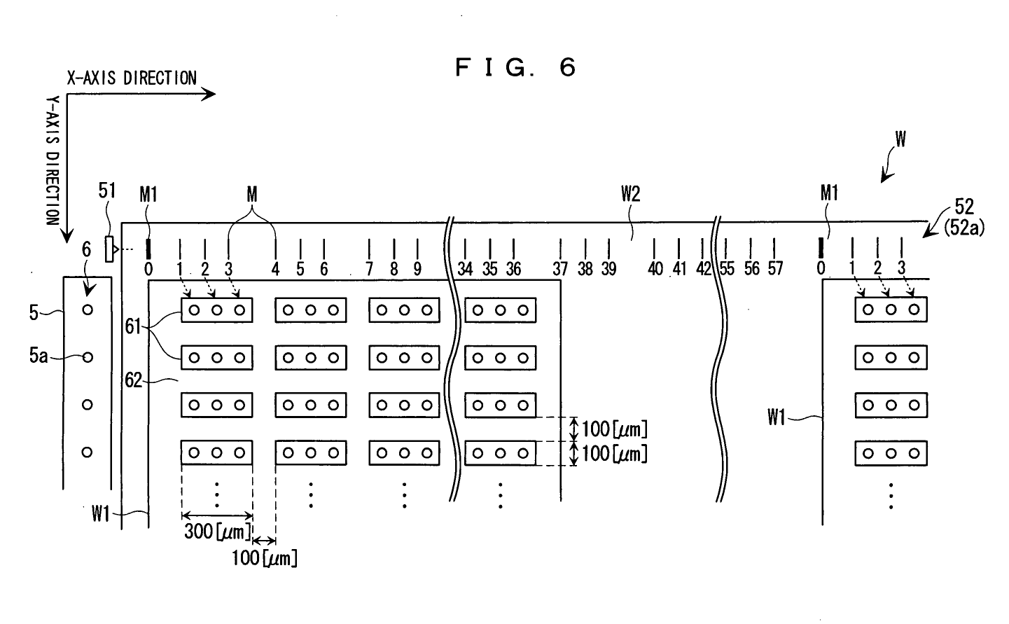

Next, a description will now be made about the control of ejection drive of the function liquid based on ejection pattern data (ejection signal) and the result of detection by the linear scale 52. FIG. 6 is a plan view showing an arrangement of pixels on the imaging region W1 and FIG. 7 is a perspective view thereof. Here, in order to simplify the description, a description will be made about a case in which imaging is performed by a function liquid droplet ejection head 5 having arranged therein a single row of nozzle array 6. In FIG. 6, the reference numerals given below the linear scale 52 (marking) are only to show the mark position and count number, and are not actually given on the workpiece W.

As shown in both figures, the imaging region W1 has cavity portions 61 into which the function liquid is ejected and which constitute the pixels, and bank portions 62 which partition the cavity portions. The bank portions 62 are subjected to liquid-repellent treatment (introduction of fluorine group). It is thus so arranged that some errors in ejection position can be tolerated. The cavity portions 61 have respectively a size of 300 μm in the X-axis direction and 100 μm in the Y-axis direction, and are arranged at a distance of 100 μm in the X-axis direction and the Y-axis direction, respectively.

In the non-imaging region W2, there is formed a linear scale 52 which is made up of a single line of mark array 52a extending in the X-axis direction. At the detection start position of each of the imaging regions W1 (in the illustrated example, at the position which falls on a line of extension of the left side end portion of each of the imaging regions W1), there is provided a reference mark M1. The imaging work is performed by ejecting the function liquid three times into each of the pixels (cavity portions 61). To cope with the number of ejections, each of the pixels has correspondingly three marks (e.g., mark 1, mark 2, mark 3). Out of consideration of the deviation between the timing of detection by the linear sensor 51 and the timing of ejecting the function liquid from each of the nozzles 5a (i.e., the deviation due to the transportation of the workpiece W), these three marks are marked somewhat on an upstream side of the transfer direction (in the X-axis direction) as compared with the position of landing of the function liquid (circular marks in the figure).

In the non-imaging region W2, on the other hand, the marking is made to be on the same arrangement as the marking (e.g., marks 1-3) corresponding to the imaging region W1. Namely, in this case, the workpiece W is formed such that the marking becomes possible in the same arrangement both in the imaging region W1 and in the non-imaging region W2. In this manner, since the marking to correspond to the non-imaging region W2 is made to be of the same arrangement as the marking to correspond to the imaging region W1, by measuring the detection timing, a detection error such as skipping in reading or double counting (counting the same mark in succession), if occurred, can be detected. In other words, by the fact that the marking of the same arrangement continues, the distance between marks can be set to a predetermined range (in the illustrated example, the range of the distance between marks 1-2 (minimum) and the distance between marks 3-4 (maximum). If the interval of detection timing is shorter than the transfer time corresponding to the above-described minimum marks, or longer than the transfer time corresponding to the above-described maximum marks, it can be deemed to be a detection error.

Instead of being limited to the above example, it may also be so arranged that, in the non-imaging region W2, marking is made at a constant pitch below the maximum pitch (distance between marks 3-4) of the mark corresponding to the imaging region W1 so that, by measuring the detection timing, the detection error can be detectable.

By the way, the above reference mark M1 is made up of a mark which is slightly larger in width that the other marks as illustrated. By the detection of this reference mark M1, the counting of the linear scale by the linear sensor 51 is reset (see corresponding table in FIG. 8). Therefore, in the illustrated example, after having detected up to marks 1-57, the counting returns to zero upon detection of the reference mark M1. Then, the corresponding marks 1-57 are detected from the imaging region W1 to the non-imaging region W2 that is positioned next thereto. In this manner, by providing the reference mark M1 in each of the imaging regions W1, even if a detection error occurs, it can be compensated for in each of the imaging regions (in a space between marks 0-1). Further, since the reference mark M1 shows the position of starting the detection in each of the imaging region arrays W1-1 through W1-d (see FIG. 4), after a detection error has occurred, the ejection accuracy can be maintained from the position of starting ejection in the subsequent imaging region.

The mode of the reference mark M1 may alternatively be of other shapes such as “+” or “×” instead of the mark of larger width. Or else, by making the color and density different from the other marks, the difference in reflection factor in optical irradiation may be detected. Otherwise, a sensor for the reference mark is disposed adjacent to the linear sensor 51 and by making the size of the reference mark M1 larger than the other marks (by making the line segment longer), the reference mark M1 may be detected by the sensor for the reference mark.

By the way, the function liquid droplet ejection head 5 has disposed therein a nozzle array 6 which is made up of a plurality of nozzles 5a, and the nozzle pitch thereof corresponds to the pixel pitch. The length of the nozzle array 6 is so arranged as to cope with all of the imaging regions W1 (i.e., a length capable of imaging all the imaging regions at a single main scanning). Therefore, the ejection/non-ejection of the function liquid can be controlled for driving for each of the nozzle arrays 6. In this connection, preferably, the nozzle corresponding to the non-imaging region W2 in the Y-axis direction (i.e., the interval between the imaging regions W1) is set to be normally non-driving or, by using the function liquid droplet ejection head 5 for exclusive use with the illustrated workpiece W, the nozzle 5a corresponding to the non-imaging region W2 does not exist.

A description will now be made, with reference to FIG. 8, about a corresponding table 350 which is used in detecting the linear scale 52 constituted as described above. As shown in the figure, as regards the mark group (marks 1-36) corresponding to the imaging region W1, an ejection signal is generated (attaining the state of “ON”) to thereby eject the function liquid from each of the nozzles 5a (nozzle array 6). As regards the mark group (marks 37-57) corresponding to the non-imaging region W2, the function liquid is not ejected (attaining the state of “OFF”) from each of the nozzles 5a. In this manner, based on the corresponding table 350, the ejection pattern data of each of the nozzle arrays 6 is generated. The control for driving the ejection of the function liquid from each of the nozzle arrays 6 is performed based on the ejection pattern data and the detection timing of the linear scale 52.

As regards the corresponding table 350, there may be used one which covers the imaging of the entire workpiece W. However, since the cycle of the marks 0-57 is repeated as noted above, it may be so arranged that a table to cover only the marks 0-57 is prepared to thereby reduce the amount of memory.

As described above, according to the liquid droplet ejection apparatus of this embodiment, since the linear scale 52 is constituted by a mark array 52a which is marked on the workpiece W, the accuracy of ejection of the function liquid can be maintained even in case the workpiece W varies in size due to a temperature difference. In addition, the reference mark M1, which is marked in a mode different from that of the other marks, is provided for each of the imaging regions W1-a through W1d. Since the counting of the liner scale 52 is reset based on the detection of the reference mark M1, should a counting error occur such as skipping of reading or double counting, the error can be compensated for each of the imaging regions W1-a through W1-d. Further, since the reference mark M1 shows the position of starting detection of the various imaging region arrays, the ejection accuracy can be maintained from the start position of ejection in the subsequent imaging region, after the occurrence of an error.

In addition, since the linear scale 52 is formed in the non-imaging region W2, no effect will be given to the imaging region W1 which is thereafter cut off for use as a product. Further, since the number of marks corresponding to the respective imaging regions W1a through W1d of the linear scale 52 is equal to the number of ejection of the function liquid into the respective imaging regions W1, it is possible in the imaging region W1 to control for driving the timing of ejection of the function liquid by a simple constitution such as ejecting once upon detection of the mark. Therefore, the load on the CPU 210 can be decreased.

In the above-described embodiment, the number of ejection of the function liquid into each of the pixels and the number of marks corresponding to each of the pixels are made equal to each other. It is also possible to double the number of marks so that the function liquid can be ejected (ejection signal is generated) at every other detection of the marks, thus adequately changing the number of marks.

Further, although the linear scale 52 is presumed to extend in the main scanning direction (X-axis direction), it may alternatively be formed also in the sub-scanning direction (Y-axis direction) so that the amount of movement of the head unit 15 in the sub-scanning direction can be accurately detected.

In the above-described embodiment, it is so arranged that the function liquid is not ejected depending on the detection of the marks M (marks 37-57) which correspond to the non-imaging region W2. It may alternatively be so arranged that, even in the non-imaging region W2, the function liquid is ejected in the same manner as in the imaging region W1 so that the ejection can be used as a test pattern for the detection of deviation in the landing position of the function liquid. In other words, by comparing the position of landing of the function liquid ejected into the non-imaging region W2 and the mark position, the deviation is measured to thereby adjust the ejection timing based thereon. According to this arrangement, the ejection accuracy can further be improved. In order to eliminate the waste consumption of the function liquid, preferably, the nozzle 5a to eject for test pattern shall be limited to one or two in number.

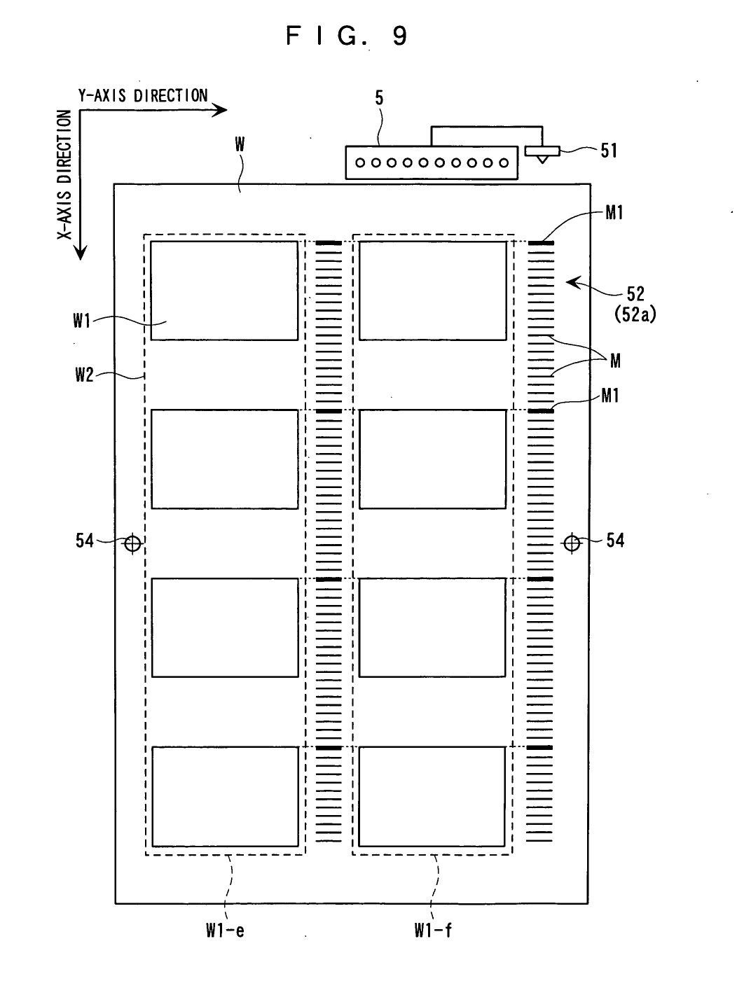

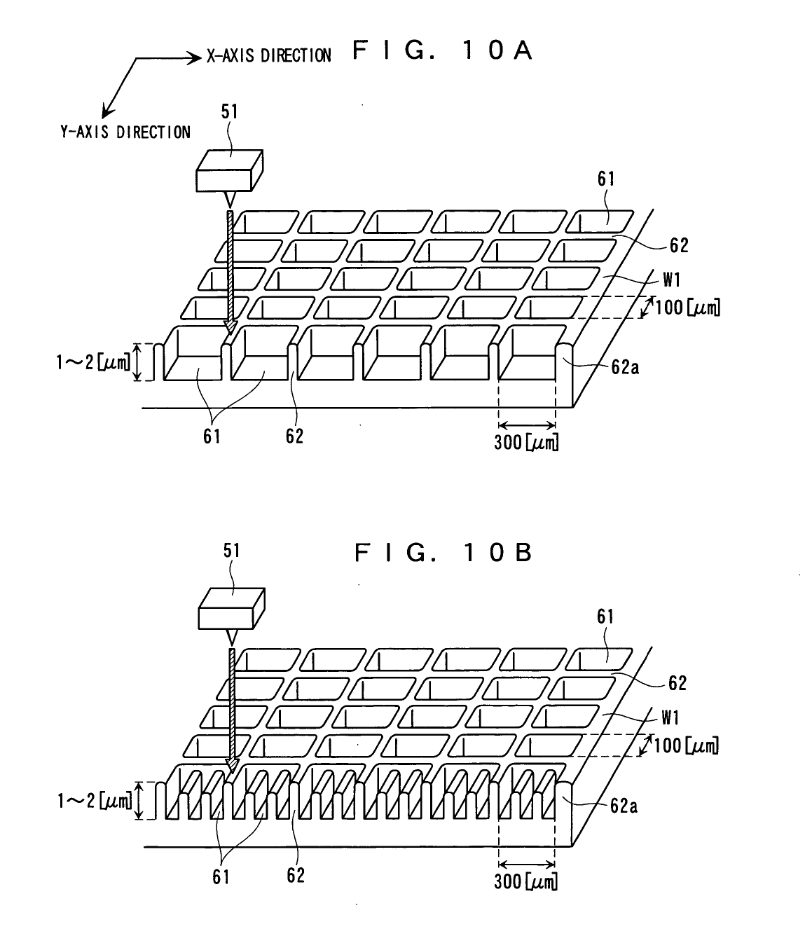

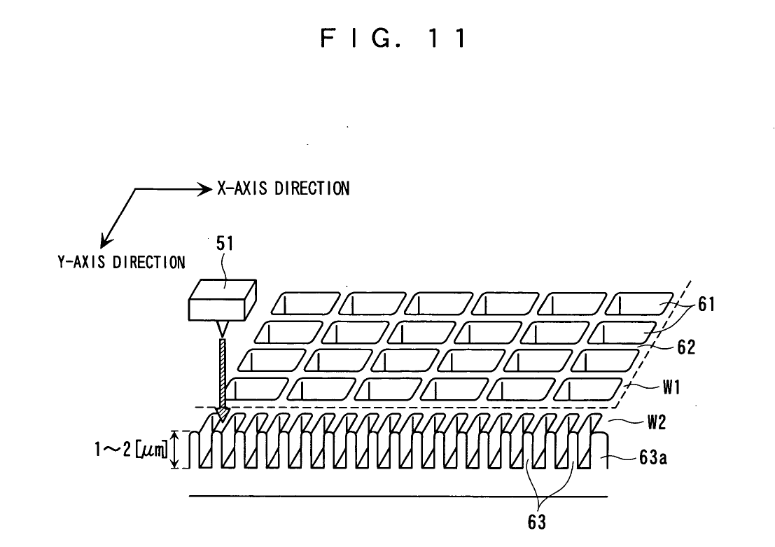

In the above embodiment, the length of the nozzle array 6 has a length corresponding to all of the imaging regions W1 (i.e., the length capable of imaging all the imaging regions at a single main scanning) so that the imaging of the entire imaging region can be performed at a single main scanning. In case the length of the nozzle array 6 does not have a length to correspond to the entire imaging region, imaging must be performed by main scanning in a plurality of times (i.e., movement of the workpiece W in the main scanning direction). Therefore, in such a case, the mark array 52a shall preferably be formed depending on the number of scanning. For example, as shown in FIG. 9, in case two imaging regions W1-e, W1-f are formed at a distance from each other in the Y-axis direction and in case a nozzle array 6 is uses which is capable of imaging each of the imaging region arrays W1-e, W1-f at a single scanning, respectively, the imaging must be performed by a total of two times of scanning. Here, in case only one mark array 52a on the right side in the figure is marked as the linear scale 52, the detection of the mark array 52a becomes impossible in case the imaging is performed for the imaging region W1-e on the left side in the figure, because the positions of the function liquid droplet ejection head 5 and the linear sensor 51 are fixed (see FIG. 3). However, in the example as shown in FIG. 9, since the mark array 52a is formed also at a position to correspond to the imaging region array W1-e on the left side in the figure, imaging can be performed based on the detection result of the linear sensor 51 (linear encoder 50), in the same manner as in the imaging region array shown on the right side in the figure. In other words, by having the number of scales (number of mark arrays) equivalent to the number of relative scanning between the workpiece W and the function liquid droplet ejection head 5 (head unit 15), the ejection accuracy can be maintained even in case the imaging is performed by dividing the scanning into a plurality of times).

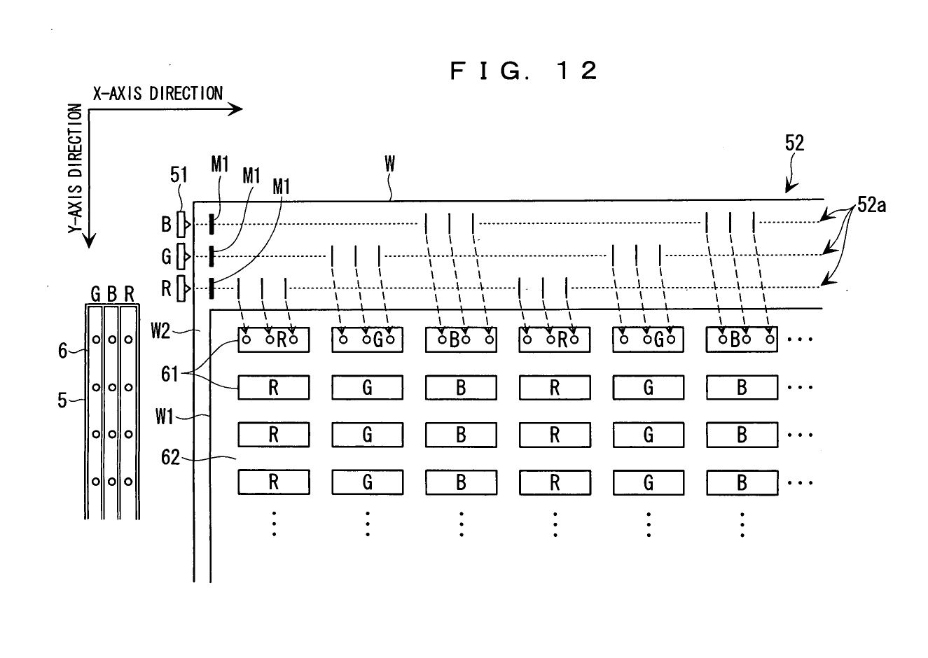

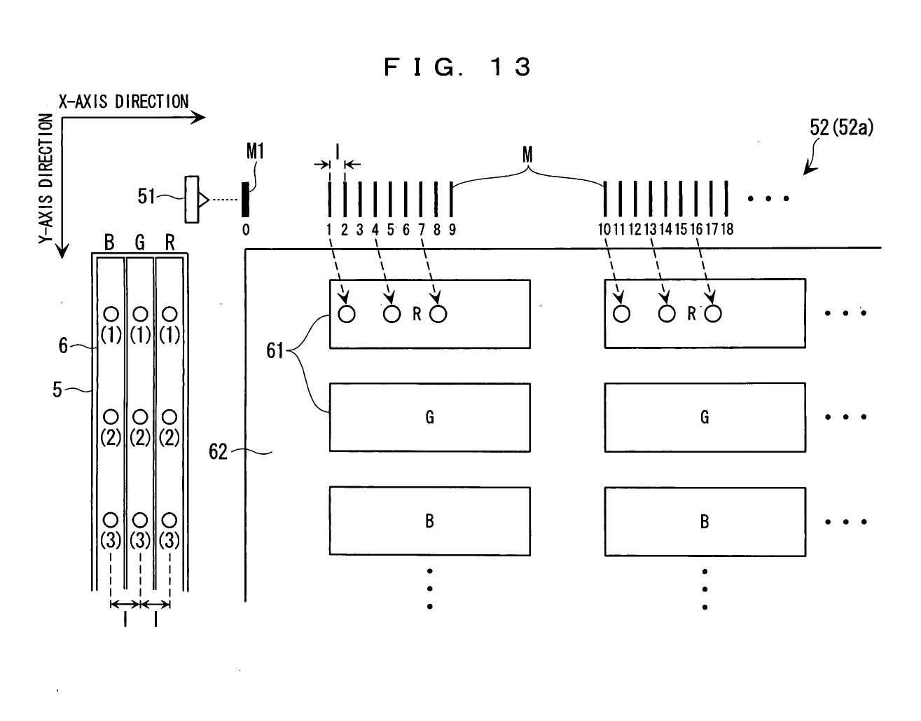

Next, a description will now be made about a second embodiment with reference to FIGS. 10A, 10B and 11. In the above-described first embodiment, the linear scale is constituted by the mark array 52a which is marked in the non-imaging region W2. In this second embodiment, on the other hand, the bank portion 62 constitutes that object to be detected by the linear sensor 51 which corresponds to the linear scale 52. Therefore, the following description will be made mainly about what is different from the first embodiment.

FIG. 10A is a perspective view showing the pixels (cavity portions 61) which are arranged in matrix on the imaging region W1, and the bank portions 62 which partition the pixels. As described above, the cavity portions 61 have the size of 300 μm in the X-axis direction and 100 μm in the Y-axis direction. The height of the bank portions 62, on the other hand, is about 1 to 2 μm. In order to facilitate understanding, the bank portions 62 are exaggerated.

As shown in the figure, the linear sensor 51 outputs encoder signals by detecting the bank portions 62 in the front endmost pixel array in the figure. For example, in case the function liquid is ejected, e.g., three times into a single cavity portion 61, three ejection signals are generated upon detection of a single bank portion 62. In the non-imaging region W2, the bank portions 62 (only those equivalent to one array which is to be made object of detection) are continuously formed (not illustrated) on lines of extension of the pixel arrays which are made to be objects of detection (in the illustrated example, in the front endmost pixel array).

By the way, in this embodiment, since the bank portions 62 which are made the objects of detection are also formed in the imaging region W1, it is not preferable to form the bank portions 62, e.g., of larger width which is equivalent to the reference mark M1 (see FIG. 6) at the first detection position (bank portion 62) corresponding to each of the imaging regions W1 as in the first embodiment. This is because the reference mark M1 is for the purpose of compensating for the ejection errors and, therefore, causes the nozzle driving to be “non-ejection (OFF).” In other words, if the reference mark M1 is formed in the first bank portion corresponding to each of the imaging regions W1, there will occur a problem in that the function liquid is not ejected into the first pixel array (that is arranged in the Y-axis direction). As a solution, in this embodiment, the last bank portion 62a corresponding to each of the imaging regions W1 is formed in larger width so that the counting is reset upon detection of the last bank portion 62a. According to this arrangement, a detection error, if occurred, can be compensated for.

If an arrangement is made such that an ejection signal is generated at the time of detection of the reference mark (at the time of detecting the bank portion of larger width), it is possible to form the reference mark M1 at the first detection position corresponding to each of the imaging regions W1. Alternatively, as shown in FIG. 10B, an arrangement may be made such that bank portions 62 which are still smaller in bank height are provided between the respective bank portions 62 only in the pixel array (arranged in the X-axis array) equivalent to one array to be made the object of detection, so that the number of ejection and the number of banks for each pixel are made equal to each other. According to this arrangement, it is possible to perform a simple drive control in which the ejection signal is generated each time the bank portion 62 is detected. Further, by making the bank height of the added bank portions 62 smaller in the pixel array equivalent to one array to be made the object of detection, it becomes possible to eject the function liquid into the region (cavity portion 61) which is similar to those in the other pixel arrays. There is thus no problem in that the pixel size becomes smaller only in the pixel array which is the object of detection.

A modified example of this embodiment will be described with reference to FIG. 11. In the example illustrated therein, the detecting bank portions 63 are formed in the non-imaging region W2, for use in detecting the position by the linear sensor 51 in the same material and in the same steps as those of the bank portions 62. In this case, an ejection signal is generated for a bank portion 63. Therefore, in the illustrated example, for a single pixel the function liquid is ejected three times. In this example, too, the last bank portion 63a corresponding to each of the imaging region W1 is formed into a larger width so that, upon detection of the last bank portion 63a, the count can be reset.

The bank pitch of the detecting bank portions 63 need not always be formed at the same pitch. In addition, since the detecting bank portions 63 are formed in the non-imaging region W2, the first bank portion corresponding to each of the imaging region W1 can be formed into a larger width like in the first embodiment, so that the count can be reset.

As described above, according to this embodiment, since the bank portions 62 which partition the pixels are used as the linear scale, the ejection accuracy can be maintained even in case there is used a workpiece W which is subject to thermal expansion or deformation accompanied by temperature changes.

In addition, by forming the detecting bank portions 63 which have the same steps and the same material as the bank portions 62 in the imaging region W1, they can be used as the linear scale 52. Further, since the detecting bank portions 63 are formed in the non-imaging region W2, the bank pitch can be freely set depending on the number of ejection of the function liquid.

In either of the bank portions 62 which are formed in the imaging region W1 and which are made the object of detection and the detecting bank portions 63 which are formed in the non-imaging region, only the portions corresponding to the imaging region arrays W1-a through W1-d may be formed. According to this arrangement, there is no need of forming the bank portions in the non-imaging region W2 (or the detecting bank portion corresponding to the non-imaging region W2). In this case, the bank portions 62a, 63a of larger width are not always necessary. As regards the arrangement in which the detection objects (marks M) are thus provided in the portion corresponding to the imaging region W1, a description will be made hereinafter with reference to the fourth embodiment.

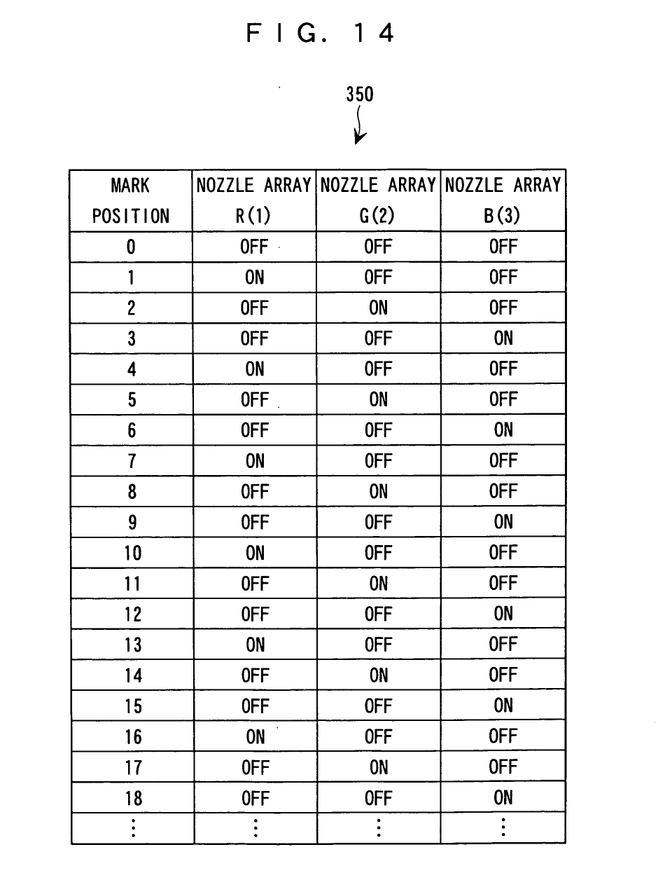

Next, a description will now be made about a third embodiment of this invention with reference to FIGS. 12 through 16. In this embodiment, reference is made to a case in which imaging is made with plural kinds of function liquids (here, function liquids of red, green and blue in color) and in which each of the function liquids is ejected from the nozzle array 6. It is assumed here that the function liquid of red, green and blue in color are ejected from the nozzle array R, nozzle array G and nozzle array B, respectively, so as to reach from the initial position to the imaging region W1 in the order described.

FIG. 12 shows the linear scale 52 in case the imaging is made to the imaging region W1 of stripe arrangement of the same color in the Y-axis direction. As shown in the figure, each of the mark arrays 52a extends in the X-axis direction in parallel with one another to correspond to each of the colors (corresponding to red, green and blue from the bottom side of the figure). In this embodiment, too, since imaging is performed by ejecting the function liquid droplet three times into each pixel, three mark are respectively marked correspondingly. In addition, since the pixels are arranged in the order of red, green and blue in the X-axis direction, each of the mark arrays 52a is marked with positional deviation so as to correspond to the respective colors. Further, each of the mark arrays 52a has a reference mark M1 on a line of extension of the left end portion of the imaging region W1 in the figure so that the detection error can be compensated for thereby. Further, by arranging the reference marks M1 on the same line of extension, a possible deviation in the X-axis direction in position of detection by each of the linear sensors 51 can be detected. The linear sensors 51 are provided in parallel with one another in a position respectively capable of detecting the mark array 52a corresponding to each of the colors.

In this manner, according to this embodiment, since the mark array 52a which is formed for each of the colors of the function liquid is detected, there is no need for a table which correlates the mark position and the color of the function liquid to be ejected at the time of detecting the color in question, or a program, or the like. Each of the nozzle arrays 6 can thus be simply controlled for driving.

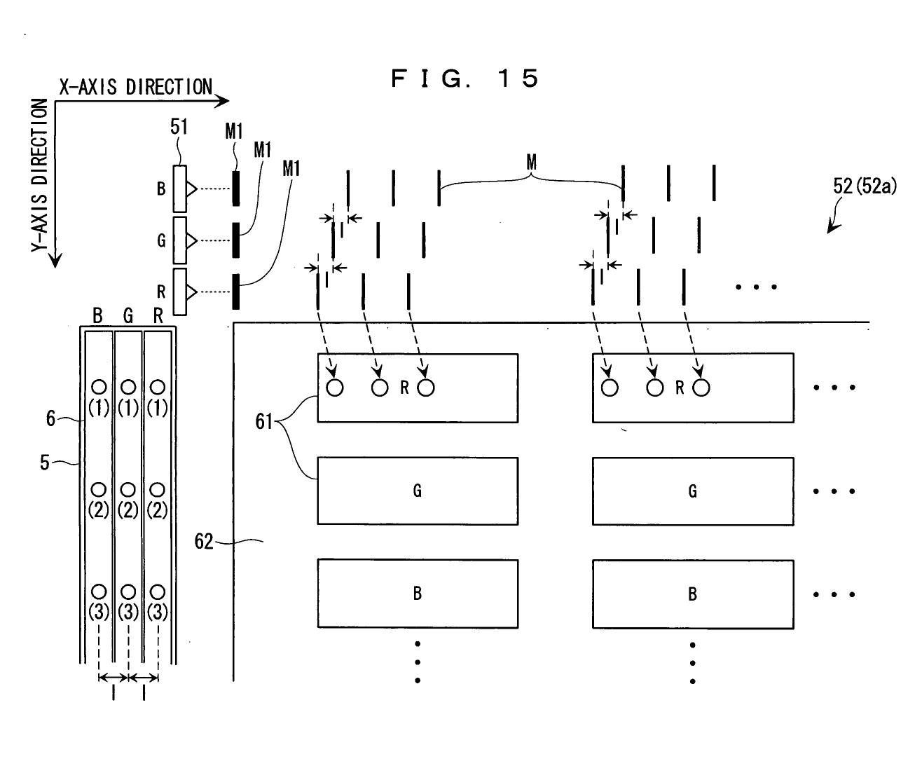

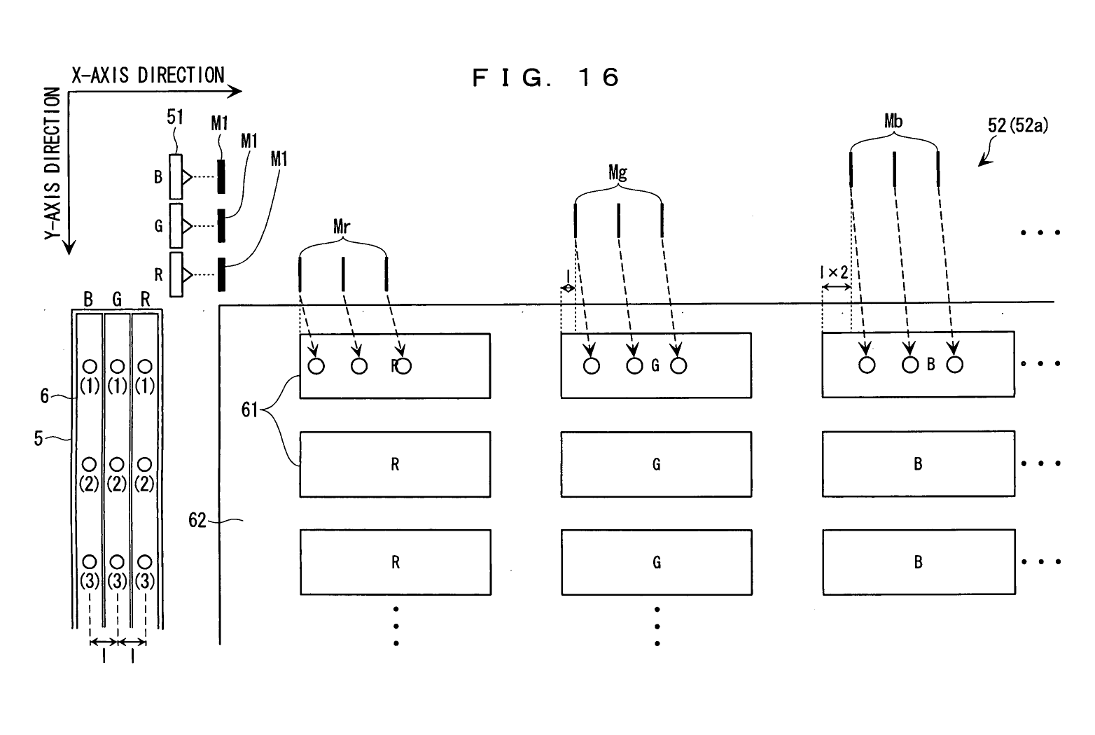

By the way, as shown in FIG. 13, in case different colors of function liquids are ejected from each of the nozzle arrays 6 and in case different colors of pixels are arranged in the sub-scanning direction (Y-axis direction), if an ejection signal is generated at the same timing for all of the nozzle array 6, there will occur a deviation in the ejection position (position of landing) depending on the distance 1 between the respective nozzle arrays 6. As a solution, it is necessary to determine the ejection timing considering the distance between the respective nozzle arrays 6. Therefore, a description will now be made about a method of controlling to drive the ejection/non-ejection of the function liquid droplets of each of the nozzle arrays 6 by using a corresponding table 350 (see FIG. 14) which has given due consideration to the distance between the respective nozzle arrays 6. In case different colors of pixels are arranged in the sub-scanning direction, the nozzles 5a arranged in the nozzle arrays 5a cannot be simultaneously driven. Therefore, in the following description, reference is made: to the nozzle driving, regarding the nozzle array R, of the nozzle numbers 1 (hereinbelow, the nozzle numbers are shown in parentheses), (4) . . . ; to the nozzle driving, regarding the nozzle array G, of the nozzle numbers (2), (5) . . . to the nozzle driving, regarding nozzle array B, of the nozzle numbers (3), (7) . . . (nozzle numbers (4) through (7) are not illustrated).

For example, as shown in FIG. 13, suppose that the function liquid of each of the colors is ejected three times for each of the pixels so as to perform marking corresponding to one pixel at a pitch equal to the distance 1 between the nozzle arrays 6. Then, if the function liquid droplet of R color is ejected upon detection of positions of mark 1, mark 4, and mark 7, the function liquid droplet of G color will be rejected upon detection of positions of mark 2, mark 5, and mark 8. In other words, as shown in the corresponding table 350 in FIG. 14, the ejection signal for the nozzle array G will be generated, relative to the nozzle array R, upon detection of the mark at a position which is offset by the distance 1 between the nozzles. Similarly, the ejection signal is generated for the nozzle array B, relative to the nozzle array G, upon detection of the mark at a position which is offset by the distance 1 between the nozzle.

As described above, according to this embodiment, by using the corresponding table 350 which corresponds to each of the nozzle arrays 6 so that, by taking into consideration the distance between the nozzle arrays 6, the ejection signals are generated upon detection of the mark at a position which is offset by the amount equivalent to that distance, even in case the imaging is performed by a plurality of nozzle arrays 6, each of the nozzle arrays 6 can be easily controlled without using a processing program, or the like. In addition, according to this arrangement, it becomes possible to reduce the amount of data required for control program to generate the ejection signal (ejection pattern data). It becomes thus possible to store the control program in a portable memory medium (CD-ROM, DVD, or the like) which is commercially available.

The distance between marks need not always be equal to the distance 1 between each of the nozzle arrays, but may be of a pitch which becomes a fraction of integer-multiples of the distance between the nozzle arrays. For example, the distance between the mark in case the number of mark of the mark arrays 52a shown in FIG. 13 is doubled becomes ½. In that case, the ejection signal of the nozzle arrays 52a may be generated upon detection of the mark position 2, mark position 8, and mark position 14. In other words, there may be formed a table which can determine ejection/non-ejection of the function liquid in correspondence with each the position of each mark.

Further, this embodiment is applicable to a case in which, instead of ejecting different kinds of function liquids from each of the nozzle arrays 6, the same kind of function liquid is ejected from a plurality of nozzle arrays 6. Still furthermore, in case a plurality of function liquid droplet ejection heads 5 are used, the ejection signal may be generated upon detection of a mark position which is offset by the distance between the heads (i.e., the distance between the nozzles).

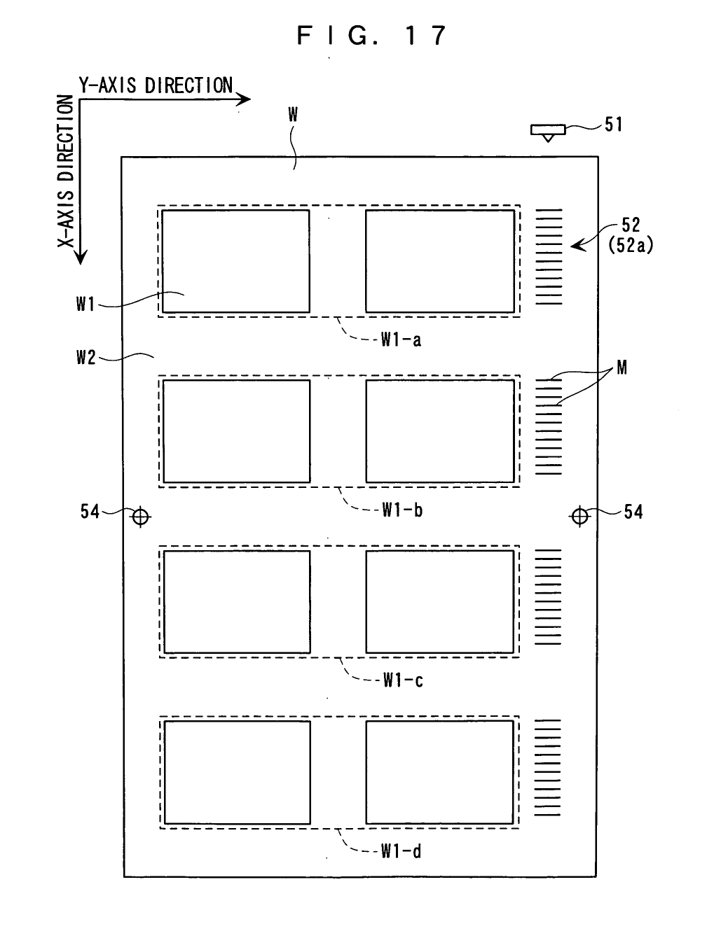

In addition, in the example shown in FIG. 13, the mark array 52a is detected by a single linear sensor 51. It may be so arranged, as shown in FIG. 15, that the ejection signal is generated upon detection of the marks which are marked at positions offset by the distance 1 between the nozzle arrays. According to this arrangement, without using a corresponding table for each of the nozzle arrays 6, all of the nozzle arrays 6 can be controlled for driving by using the same corresponding table.

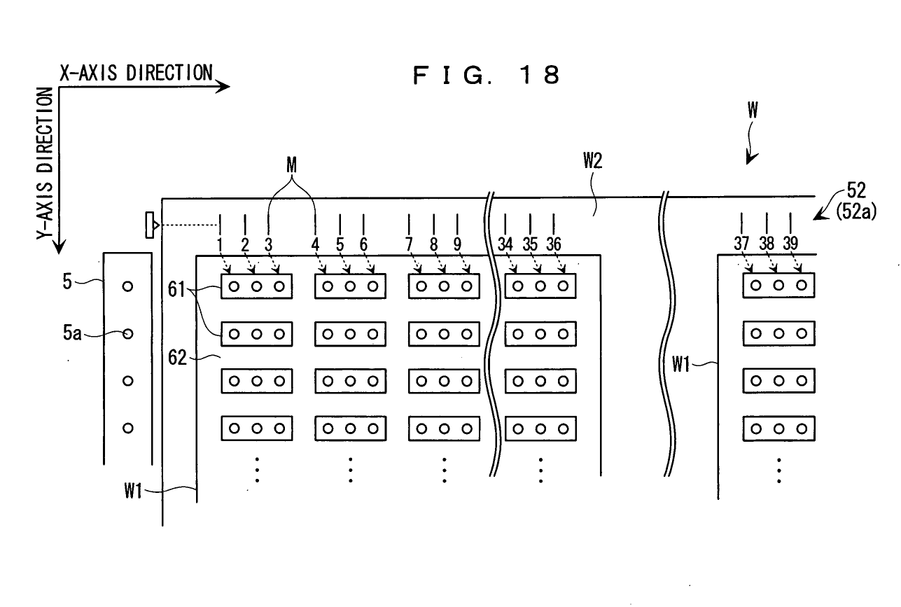

Further, as shown in FIG. 16, in case imaging is made of a stripe arrangement in which the pixels of the same color are arranged in the sub-scanning direction, the ejection signal can be generated for each of the nozzle arrays 6. Namely, the arrangement of the mark group Mg corresponding to the pixels of green color is offset, relative to the arrangement of the mark group Mr corresponding to the pixels of red color, by the distance 1 between the nozzle array R and the nozzle array G. Similarly, the arrangement of the mark group Mb corresponding to the pixels of blue color is offset, relative to the arrangement of the mark group Mr corresponding to the pixels of red color, by two times the distance 1 between the nozzle array R and the nozzle array B. According to this arrangement, in the same manner as in the example of FIG. 15, without using a corresponding table for each of the nozzle arrays 6, all of the nozzle arrays 6 can be controlled for driving by using the same corresponding table.

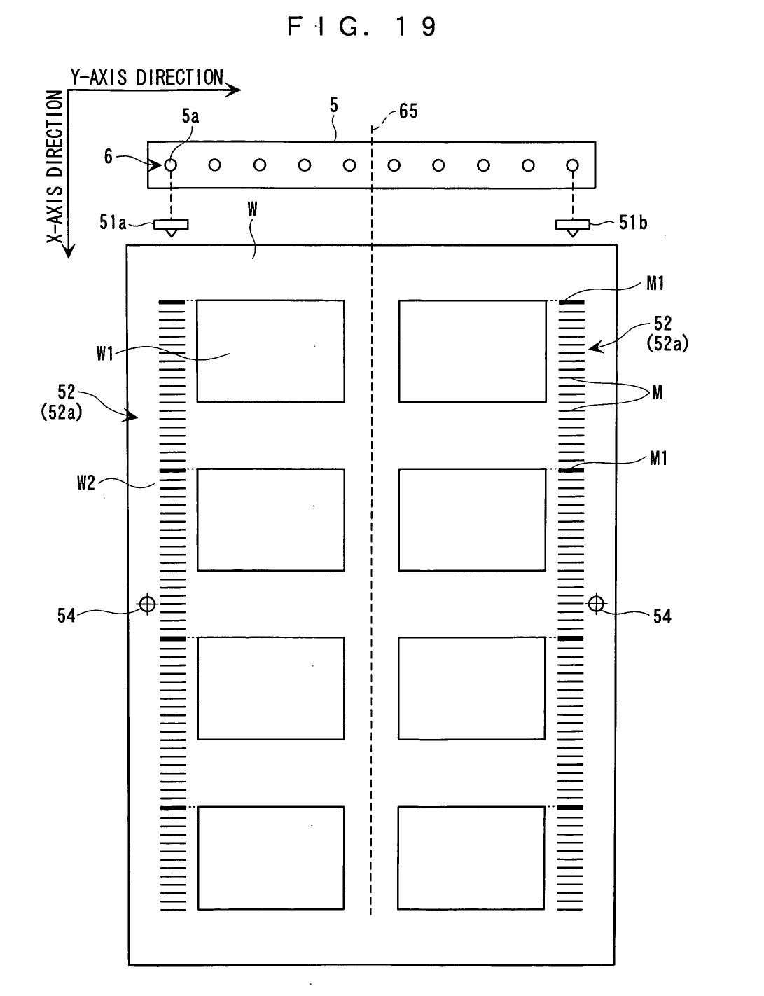

Next, a description will be made about a fourth embodiment of this invention with reference to FIGS. 17 and 18. In the above-described embodiments, the linear scale 52 is arranged by mark array(s) 52a which is (are) arranged continuously in the X-axis direction. The linear scale 52 of this embodiment, however, is constituted by mark arrays 52a which are arranged separate from one another for each of the imaging regions. Therefore, a description will be made mainly about the points which are different from the first embodiment. In order to facilitate the description, a description will be made by assuming a case in which the imaging is made by a single row of nozzle array 6.

As shown in FIG. 17, the mark array 52a which constitutes the linear scale 52 of this embodiment is arranged separately for each of the imaging regions which are arrayed in a direction perpendicular to the X-axis direction (direction of detection by the linear sensor 51). Therefore, on the workpiece W which is made up of four imaging regions W1-a through W1-d arrayed in the X-axis direction, the linear scale 52 is constituted by four mark arrays 52. Each of the mark arrays 52a is marked by the same marks M, and there is no reference mark M1 like in the first embodiment.

Further, as shown in FIG. 18, the mark array 52a corresponds, starting with the detection start position (mark 1), to mark positions 1 through 36, 37 through 72, 73 through 108, respectively (mark positions 40 and downwards are not illustrated). The number of marks corresponding to each of the pixels (cavity portions 61) is disposed three each which is equal to the number of ejection of the function liquid droplets. Further, since the mark array 52a is marked only at positions corresponding to each of the imaging region arrays W1-a through W1-d, the nozzle arrays 6 corresponding to all of these mark positions are set to be “ejection (ON).” In other words, in this embodiment, it is possible to drive for controlling the ejection timing by a simple constitution in which the function liquid droplet is ejected once at every detection of the mark. Therefore, there is no need of using the corresponding table 350 as shown in FIG. 8. In addition, since the ejection signal is generated for every detection of the mark (i.e., the mark position is not counted), even in case there occurs skipping of reading or double counting, no effect is given to the subsequent ejection of the function liquid droplets.

As described, according to this embodiment, since the mark arrays 52a which constitute the linear scale 52 are arranged separately for each of the imaging region arrays which are arrayed in a direction perpendicular to the direction of detection by the linear sensor 511, and since the number of marks to correspond to each of the imaging regions of the mark arrays 521 is equal to the number of ejection of the function liquid into each of the imaging regions, the ejection timing of each of the nozzle arrays 6 can be driven for controlling by a simple constitution in which the function liquid is ejected once upon every detection of the mark. Therefore, the load on the CPU 210 can be reduced, and the imaging can be performed only by the detection of marks without using a corresponding table which correlates the mark position with the ejection/non-ejection of the function liquid.

In case where the number of ejection of the function liquid and the number of marks do not simply coincide with each other, the corresponding table will sometimes be required also in this embodiment. Also in such a case, there is no need of providing the reference mark M1 like in the first embodiment because, in this embodiment, the starting of detection of each of the imaging regions W1 can be recognized by the separating distance between the mark arrays 52a. Therefore, in case a detection error such as skipping in reading or double counting occurs, the detection error can be compensated for from the ejection start position of the subsequent imaging region W1, thereby maintaining the ejection accuracy.

A description will now be made about a fifth embodiment of this invention with reference to FIGS. 19 through 21. According to the above-described embodiments, the detection of position is performed by a single linear sensor 51 (in case imaging of red, green, and blue colors is performed, three linear sensors 51 corresponding to each of the colors). In this embodiment, on the other hand, detection of position is performed by using two linear sensors 51, 51 which are away from each other in the Y-axis direction and, based on the deviation in outputs of the two linear sensors 51, 51, the ejection timing of each of the nozzles 51a is corrected. According to this arrangement, there is an effect in that the deviation in the ejection position of the function liquid due to transportation deviation (yawing, or the like) of the workpiece W can be corrected. Therefore, a description will be made mainly about what is different from the above-described embodiments.

As shown in FIG. 19, the linear scale 52 according to this embodiment is constituted by two mark arrays 52a which are arranged at a distance from each other in the Y-axis direction and is arranged in parallel with each other in the neighborhood of the side ends in the Y-axis direction of the workpiece W, respectively. Each of the mark arrays 52a is formed such that the mark distance in the X-axis direction, the number of marks, and the position of arrangement become identical with each other. In addition, each of the mark arrays 52a is provided with a reference mark M1 which is to compensate for the detection deviation for each of the imaging regions W1, and the position of arrangement of the reference mark M1 is also the same in the X-axis direction.

The linear senor 51, on the other hand, is arranged in a position which corresponds to each of the mark arrays 52a. In this embodiment, since the linear scale 52 is made up of two mark arrays 52a, detection is made of the respective mark arrays 52a by means of two linear sensors 51a, 51b. The linear sensors 51a, 51b are arranged in the same positions, as seen in the Y-axis direction, as the nozzles 5a, 5a on the left and right ends of the function liquid droplet ejection head 5, or in positions which are away, by the same distance, from the center position of the nozzle array 6.

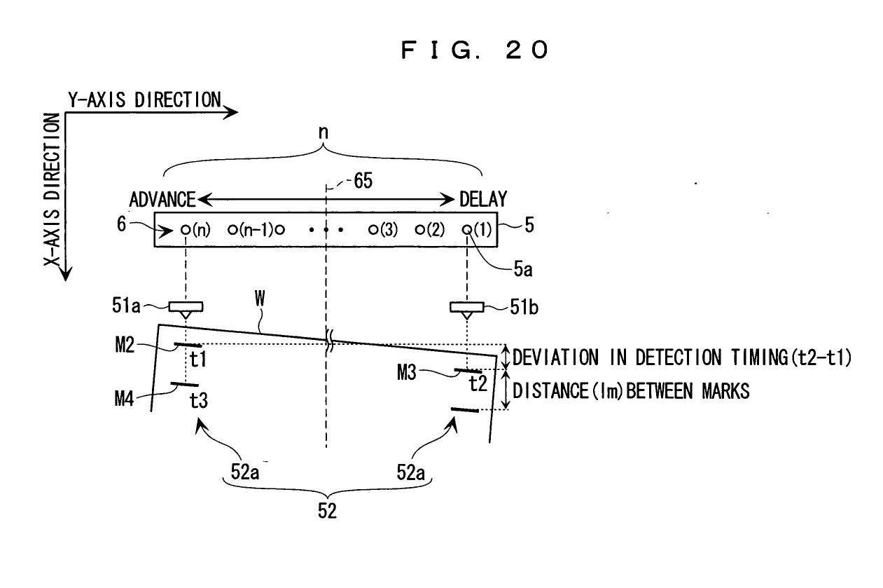

By the way, in this embodiment, the imaging in the main scanning direction is performed by the movement of the workpiece W relative to the function liquid droplet ejection head 5. At this time, as shown in FIG. 20, it is assumed that the movement of the workpiece W deviates from the perpendicular direction relative to the function liquid droplet ejection head 5. For example, let the time of detection of an arbitrary mark M2 by the linear sensor 51a be defined as t1, and let the time of detection of mark M3 on a line of extension (the same position in the X-axis direction) of the above-described arbitrary mark by the linear sensor 51b be defined as t2. Then, when t2>t1, it can be said that there has occurred a deviation of (t2−t1) in the timing of detection.

In this case, the deviation in transporting of the workpiece W (i.e., the fact that the workpiece W is being transported in a slanted posture) can be detected by the deviation in timing of detection between the linear sensor 51a and the linear sensor 51b. Further, depending on which of the linear sensors 51 has detected first, the direction of deviation can also be detected. When t2>t1, it means that the side in which the linear sensor 51a is arranged is being transported in advance. By taking into consideration the transportation deviation, the ejection timing on the side in which the linear sensor 51b is arranged is driven to control to delay the ejection timing on the side in which the linear sensor 51b is arranged. Namely, in case n pieces of nozzles are arranged in a single function liquid droplet ejection head 5, the ejection position (position of landing) of the function liquid droplets on the workpiece W can be corrected by delaying the ejection timing by an amount (r2−t1)/n from the nozzle number (n) toward the nozzle number (1).

Here, in this case, since the mode of the marks is all the same except for the reference marks M1, a discrimination cannot be made as to whether or not the mark detected by the linear sensor 51a and the mark detected by the linear sensor 51b are arranged in the same position as seen in the X-axis direction. As a solution, let the transport velocity of the workpiece W be defined as v. Then, in case the deviation (t2−t1) in detection timing becomes equal to or larger than one-half the transport time 1m/v which is equivalent to the distance 1m between the marks, an error is announced. Regarding the distance between the marks, in case the distances between the marks are not uniform as in the example shown in FIG. 6, 1m shall preferably be the minimum value of distance between the marks (e.g., the distance between mark 1 and mark 2). In other words, when the deviation (t2−t1) in detection timing becomes equal to or larger than one-half the transport time 1m/v equivalent to the distance 1m between the marks, let the timing of detection by the linear sensor 51a of the mark M4 which is adjacent to the mark M2 be defined as t3. Then, it will no longer be able to judge whether the detected mark is M2 that is arranged in the same position in the X-axis direction as that in the mark M3, or else whether the detected mark is M4. Therefore, when a condition of (t2−t1)≧1m/v×½, i.e., (t2−t1)×v≧1m/2, is satisfied, an error is notified so as to urge the operator to stop the imaging processing or to correct the deviation in transportation.

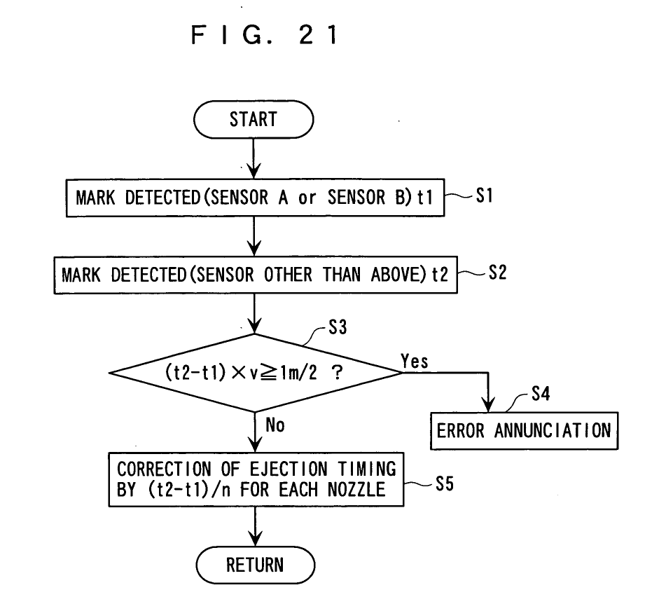

Here, with reference to a flow chart in FIG. 21, a description will now be made about the correction processing of ejection timing of each of the nozzles 5a. Let the linear sensor 51a be defined as sensor A and the linear sensor 51b as sensor B. When an arbitrary mark is detected by the sensor A or the sensor B at time t1 (S1), and a mark is detected by the other of the sensors (S2) and when, based on these detection results, a condition of (t2−t1)×v≧1m/2 is attained (S3: Yes), i.e., when the deviation in the output of the linear sensors 51a, 51b has exceeded a predetermined value, an error annunciation is made (S4). The error annunciation may be displayed on an indicator, or may be displayed on a display screen (not illustrated) which is connected to a host computer 300. Further, the annunciation may be made by a beep sound, or the like.

On the other hand, when a state (t2−t1)×v<1m/2 is attained (S3: No), the ejection timing is corrected (S5) relative to each of the nozzles 5a by an amount of (t2−t1)/n, i.e., by the amount of time obtained by dividing the deviation in detection timing between the sensor A and the sensor B by the number of nozzles. At this time, drive control is made such that, when t2>t1, the nozzle number (1) side is delayed and, when t2<t1, the nozzle number (n) side is delayed.

By the way, the condition for discrimination at step (S3) may adequately be changed, instead of when the transportation time of above ½ of 1m/v equivalent to the distance 1m between marks is satisfied, to when above ⅓ is satisfied, or the like. Further, the linear scale 52 may be constituted by a plurality of mark arrays 52a, instead of by two mark arrays 52a. Also in such an arrangement, it is preferable to provide two linear sensors 51 in the neighborhood of side ends of the workpiece W in the Y-axis direction.

As described above, according to this embodiment, the linear encoder 50 is constituted by a linear scale 52 which is made up of a plurality of mark arrays 52a, and a plurality of linear sensors 51 facing the plurality of mark arrays 52a. Based on the deviation in outputs of these plurality of linear sensors 51, the ejection timing of each of the nozzles 5a is corrected. Therefore, even in case there occurs a deviation in ejection position due to the relative movements between the function liquid droplet ejection head 5 (head unit 15) and/or the workpiece W, this can be dissolved by each unit of nozzle. In other words, the deviation in ejection position accompanied by the relative movements can be dissolved by utilizing the linear sensor 51 in a simple constitution without providing a special mechanism.

In addition, among the plurality of mark arrays 52a, at least two mark arrays 52a are respectively arranged in the neighborhood of both side ends of the workpiece W. Therefore, the deviation in ejection position accompanied by the relative movements can be more surely detected. Further, since the error notification is made when any one of the outputs of the plurality of linear sensors 51 has exceeded a predetermined amount, it is possible to urge the user to judge as to whether the processing shall be continued or not. In this case, it may be so arranged that, aside from the error notification, the imaging processing is stopped. According to this arrangement, the lowering in throughput due to the deviation in ejection position can be avoided.

In the above-described embodiments, a description was made about an example using a function liquid droplet ejection head 5 having a nozzle arrays 5 capable of imaging all of the imaging regions at a single scanning. In case the imaging is made by plural times of scanning, it is preferable to correct the ejection timing based on the positions of the linear sensors 51, 51 and the position of each of the nozzles 5a at each time of scanning. Namely, in this case, the correction of ejection timing for each of the nozzles 5a is not made by a unit of (t2−t1)/n, but the relative position in the Y-axis direction from each of the linear sensors 51, 51 is added as a parameter.

Further, in case a plurality of nozzle arrays 6 are used, or in case imaging is performed by function liquids of red, green, and blue colors, and also in case a mark array 52a corresponding to each of the nozzle arrays 6 is formed (e.g., in the case as shown in FIG. 12), the linear scale 52 shall preferably be constituted by mark arrays 52a which are equal to or more than at least two times the nozzle numbers. According to this arrangement, it is possible to eliminate the deviation in ejection position accompanied by the relative movement, e.g., while detecting the linear scale 52 for each of the nozzle arrays 6. In other words, even in case a plurality of nozzle arrays 6 are used, or in case plural kinds of function liquids are ejected, each of the nozzle arrays 6 can be simply driven for control without requiring a table correlating the mark position with the nozzle array 6 that ejects the function liquid upon detection of the mark, a processing program, or the like.

Furthermore, also in case the detecting bank portions 63 are provided in the non-imaging region W2 (in the example shown in FIG. 11), preferably, at least two detecting bank portions 63 out of a plurality of detecting bank portions 63 shall be arranged near both side portions of the workpiece W, respectively. According to this arrangement, the deviation in ejection position due to the relative movement of the head unit 15 and/or the workpiece W can more surely be detected.

In FIG. 19, there is shown an example corresponding to the first embodiment in which the mark arrays 52a are continuously arranged in the X-axis direction and which has a reference mark M1 at each of the imaging regions. Instead of being limited to this example, this embodiment can also be applicable to an embodiment in which the mark arrays 52a are separate from each other.

As explained with reference to the first embodiment through the fifth embodiment, according to the liquid droplet ejection apparatus 1 of this invention, since the linear scale 52 is made up of the mark arrays 52a marked on the workpiece W, the ejection accuracy of the function liquid can be maintained even in case the workpiece W varies in size due to temperature changes.

Particularly, according to the first embodiment of this invention, the reference mark M1 is present inside the linear scale 52, and the reference mark M1 is marked in a mode which is different from a mode of the other marks and is also provided in each of the imaging region arrays. Therefore, by resetting the counting by the linear sensor 51 of the linear scale 52 based on the detection of the reference mark M1, in case there occurs detection errors such as skipping in counting or double counting, compensation (correction) for each of the imaging region arrays can be performed. In addition, since the reference mark M1 shows the starting position of detection of each of the imaging region arrays, after a detection error occurs, the ejection accuracy can be maintained from the ejection start position of the subsequent imaging region W1.

Further, according to the liquid droplet ejection apparatus 1 in the second embodiment of this invention, the bank portions 62 which partition the pixels (cavity portions 61) are used as the linear scale 52. Therefore, even in case there is used a workpiece W which is subject to thermal expansion or deformation, the ejection accuracy can be maintained without requiring the step for forming the linear scale 52 (a step of marking on the workpiece W). In addition, in the non-imaging region W2, there is formed the detecting bank portion 63 which is formed in the same step as, and of the same material with, the bank portion 62 of the imaging region WI, and this is used as the linear scale 52. Therefore, same as above, the step for forming the linear scale 63 is not required. In addition, since the detecting bank portion 63 is formed in the non-imaging region W2, the bank pitch can be freely set depending on the number of ejection of the function liquid.

Further, according to the liquid droplet ejection apparatus 1 in the third embodiment of this invention, in case imaging is performed by a plurality of nozzle arrays 6, the distance between the nozzle arrays 6 is considered and the corresponding table 350 which corresponds to each of the nozzle arrays 6 is used so as to generate the ejection signal by detection of mark at a position offset by the distance in question. Therefore, without using a processing program, or the like, each of the nozzle arrays 6 can be easily controlled for driving. Further, according to this arrangement, the data amount required for control program to generate the ejection signal (ejection pattern data) can be minimized.

Further, according to the liquid droplet ejection apparatus 1 in the fourth embodiment of this invention, a plurality of mark arrays 52a which constitute the linear scale 52 are arranged at a distance from one another for each of the imaging regions, and the number of the marks corresponding to each of the imaging regions of the mark arrays 52a is equal to the number of ejection of the function liquid. Therefore, with the simple constitution in which the function liquid is ejected upon each detection of the mark, the ejection timing of each of the nozzle arrays 6 can be controlled for driving. As a result, the load on the control apparatus (CPU) can be decreased and also the imaging can be performed only by mark detection without using a corresponding table which correlate the mark position with the ejection/non-ejection of the function liquid.

Still furthermore, according to the liquid droplet ejection apparatus in the fifth embodiment of this invention, a plurality of mark arrays 52a are detected respectively by a corresponding plurality of linear sensors 51 and, based on a deviation in outputs of these plural linear sensors 51, the ejection timing of each of the nozzles 5a is corrected. Therefore, even in case there occurs a deviation in ejection position (landing position) accompanied by the relative deviation in transportation of the function liquid droplet ejection head 5 (head unit 15) and/or the workpiece W, it can be eliminated for each of the nozzles. In other words, by utilizing the linear sensor 51, the deviation in ejection position accompanied by the relative movements can be eliminated by means of a simple constitution without providing a special mechanism.

In the above-described embodiments, there are listed examples in which glass substrates are used as the workiece W. Instead of being limited thereto, this invention can be applied to a substrate which is subject to thermal expansion or deformation due to temperature changes, such as a substrate in which a resin is constituted into a film, or the like.

Furthermore, this invention is applicable not only to the above-described organic EL device 701, as an electrooptic device, but also to a liquid crystal display device, electron emission device, plasma display panel (PDP) device, electrophoretic display device, or the like. The electron emission device is a concept inclusive of a field emission display (FED) device. In addition, as the electrooptic device, there may be considered a device inclusive of those for forming a metallic wiring, forming a lens, forming a resist, or the like.

Furthermore, as the electronic device having mounted thereon the above-described electrooptic device, there can be listed a mobile telephone having mounted thereon a so-called flat panel display, a personal computer, various kinds of electric products, or the like.

In addition, within a range not departing from this invention, the apparatus constitution of the liquid droplet ejection apparatus 1, the mode of the marks constituting the linear scale 52, or the like, may be adequately changed.

As described above, according to the liquid droplet ejection apparatus, the method of ejecting liquid droplets, the method of manufacturing an electrooptic device, the electrooptic device, the electronic device, and the substrate of this invention, the linear scale is made up of the mark arrays marked on the workpiece. Therefore, even in case the workpiece varies in size due to the temperature change, the ejection accuracy can still be maintained. In addition, the linear scale has a reference mark at each of the imaging regions, and the counting of the linear scale by the linear sensor is reset upon detection of the mark. Therefore, in case there occurs a detection error such as skipping in reading, double counting, or the like, it can be compensated for at each of the imaging region arrays.

1. A liquid droplet ejection apparatus for forming an image on a workpiece by selectively ejecting a function liquid from a nozzle array disposed in a function liquid droplet ejection head, the apparatus comprising:
a head unit made, said head unit including the function liquid droplet ejection head mounted on a carriage;
a moving mechanism for performing a relative movement between said head unit and the workpiece, the workpiece having a plurality of imaging regions arranged in a matrix, and a non-imaging region to partition the imaging regions;
a linear encoder including a linear scale formed by a mark array continuously marked on the workpiece, and a linear sensor facing said linear scale, said linear encoder detecting a position of relative movement between said head unit and the workpiece;
drive control means for controlling drive of ejection of the function liquid from the nozzle array based on a counting result of said linear scale by said linear sensor;
wherein said linear scale has a reference mark indicating a detection start position of each of said imaging regions, said reference mark being disposed in a perpendicular direction relative to a detection direction of said linear sensor, said reference mark being marked in a mode different from a mode of other marks; and
said drive control means resets counting of said linear scale by said linear sensor based on detection of said reference mark.

2. The liquid droplet ejection apparatus according to claim 1, wherein said linear scale is formed in said non-imaging region.

3. The liquid droplet ejection apparatus according to claim 1, wherein a number of marks corresponding to each of said imaging regions of said mark array is equivalent to an ejection number of the function liquid into the imaging region.

4. The liquid droplet ejection apparatus according to claim 1, wherein each of said imaging regions has a plurality of cavity portions into which the function liquid is ejected to constitute pixels, and bank portions to partition the cavity portions, and wherein said linear sensor detects said bank portions instead of said mark array.

5. The liquid droplet ejection apparatus according to claim 1, wherein said non-imaging region has a detecting bank portion which comprises a same material as said bank portion in said imaging region and which is capable of being used as said mark array, and wherein said linear sensor detects said detecting bank portion.

6. The liquid droplet ejection apparatus according to claim 1, wherein said linear scale is equivalent to a relative number of scanning of the workpiece by said head unit.

7. The liquid droplet ejection apparatus according to claim 1, wherein said imaging region is subjected to imaging by ejection of a plurality of function liquids, and wherein said liner encoder detects linear scales made up of a number of scales equivalent to the number of kinds of the function liquids by means of said linear sensor corresponding to each of said linear scales.

8. The liquid droplet ejection apparatus according to claim 1, wherein said head unit has disposed therein a plurality of nozzle arrays through said function liquid droplet ejection head, and wherein a mark array of said linear scale has a mark interval of l/n (n is an integer above 1) when a distance between each of said nozzle arrays is defined as.

9. The liquid droplet ejection apparatus according to claim 1, wherein said head unit has disposed therein a plurality of nozzle arrays through said function liquid droplet ejection head, one of said plurality of nozzle arrays being defined as a reference nozzle and, when said liner encoder detects linear scales made up of equivalent to the number of kinds of the function liquids by means of said linear sensor corresponding to each of said linear scales, a mark array constituting each of said linear scales is disposed at a position offset by a distance from said reference nozzle array of the corresponding nozzle array, as seen in a detection direction of said linear sensor.

10. A method of ejecting liquid droplets by selectively ejecting a function liquid from a nozzle array disposed in a function liquid droplet ejection head, thereby forming an image on a workpiece, said method comprising the steps of:
performing a relative movement between a head including the function liquid droplet ejection head mounted on a carriage, and a workpiece having a plurality of imaging regions arranged in a matrix and non-imaging regions to partition the imaging regions;
detecting a position of a relative movement between said head unit and the workpiece by a linear scale formed by a mark array continuously marked on the workpiece and a linear sensor facing said linear scale; and
controlling drive of ejection of the function liquid from said nozzle array based on a result of counting of said linear scale by said linear sensor;
wherein said linear scale has formed therein a reference mark indicating a detection start position of each of said imaging regions, said reference mark being marked in a perpendicular direction relative to the detection direction of said linear sensor in a mode different from a mode of other marks; and
in said drive control step, counting of said linear scale by said linear sensor is reset based on detection of said reference mark.

11. A liquid droplet ejection apparatus for forming an image on a workpiece by selectively ejecting a function liquid from a nozzle array disposed in a function liquid droplet ejection head, said apparatus comprising:
a head unit including the function liquid droplet ejection head mounted on a carriage;
a moving mechanism for performing a relative movement between said head unit and a workpiece, the workpiece having a plurality of imaging regions arranged in a matrix and non-imaging regions to partition the imaging regions;
a linear encoder including a linear scale formed by a mark array continuously marked on the workpiece, and a linear sensor facing said linear scale, said linear encoder detecting a position of relative movement between said head unit and the workpiece;
drive control means for controlling drive of ejection of the function liquid from said nozzle array based on a counting result of said linear scale by said linear sensor;
wherein each of said imaging regions has a plurality of cavity portions into which the function liquid is ejected to constitute pixels, and bank portions to partition the cavity portions; and
said linear scale is constituted by said bank portions.

12. The liquid droplet ejection apparatus according to claim 11, wherein said bank portions are objects of detection by said linear sensor and are formed continuously in the detection direction in said non-imaging region.

13. The liquid droplet ejection apparatus according to claim 11, wherein said non-imaging region has a detecting bank portion comprised of a same material as said bank portion in said imaging region, and is capable of being used as said mark array, and wherein said linear scale is constituted by said detecting bank portion.

14. A method of ejecting liquid droplets by selectively ejecting a function liquid from a nozzle array disposed in a function liquid droplet ejection head, thereby forming an image on a workpiece, said method comprising the steps of:
performing a relative movement between a head unit including the function liquid droplet ejection mounted head on a carriage and the workpiece having a plurality of imaging regions arranged in a matrix and non-imaging regions to partition the imaging regions;
detecting a position of a relative movement between a linear scale formed of a mark array continuously marked on the workpiece, and a linear sensor facing said linear scale; and
controlling drive of ejection of the function liquid from the nozzle array based on a counting result of said linear scale by said linear sensor;
wherein said imaging regions have formed therein a plurality of cavity portions into which the function liquid is ejected to constitute pixels, and bank portions to partition the cavity portions; and
wherein said linear scale is formed by said bank portions.

15. A method of manufacturing an electrooptic device comprising forming on a workpiece a film-forming portion by a function liquid by using the liquid droplet ejection apparatus according to claim 1.

16. An electrooptic device having formed on a workpiece a film-forming portion by a function liquid by using the liquid droplet ejection apparatus according to claim 1.

17. An electronic device having mounted thereon the electrooptic device according to claim 16.

18. A substrate for use as the workpiece in the liquid droplet ejection apparatus according to claim 1.

19. The liquid droplet ejection apparatus according to claim 8, further comprising a corresponding table which correlates a mark position of said mark array with ejection/non-ejection of the function liquid of each of said nozzle arrays when said mark position is detected,
wherein said drive control means controls drive of ejection of the function liquid from each of said nozzle arrays by reference to said corresponding table.

20. A method of manufacturing an electrooptic device comprising forming on a workpiece a film-forming portion by a function liquid by using the liquid droplet ejection apparatus according to claim 11.

21. An electrooptic device having formed on a workpiece a film-forming portion by a function liquid by using the liquid droplet ej4ection apparatus according to claim 11.

22. A substrate for use as the workpiece in the liquid droplet ejection apparatus according to claim 11.
